(19) United States
(12) Patent Application Publication
(10) Pub. No.: US 2021/0312546 A1
(43) Pub. Date: Oct. 7, 2021

(54) Secret Key-Based Counterparty Matching Engine Apparatuses, Methods and Systems

(71) Applicant: FMR LLC, Boston, MA (US)

(72) Inventors: Man Hei Raymond Yim, Cambridge, MA (US); Rohan Vaswani, Nashua, NH (US); Ankush Patel, New York, NY (US); Derrick Chan, Boston, MA (US)

(21) Appl. No.: 16/842,718

(22) Filed: Apr. 7, 2020

(51) Int. Cl. G06Q 40/04; H04L 9/08; G06Q 20/38; G06Q 10/06

(52) U.S. Cl. CPC G06Q 40/04; H04L 9/0869; G06Q 2220/00; G06Q 10/06312; G06Q 20/3829

(57) ABSTRACT

The Secret Key-Based Counterparty Matching Engine Apparatuses, Methods and Systems (“SKCME”) transforms client key message, order placement input inputs via SKCME components into order placement output outputs. A matched key is determined and used to generate a set of cross times and a set of cross venues for a security identifier. Orders associated with the security identifier are obtained from counterparties and are assigned a scheduled cross time from the generated set of cross times and a scheduled cross venue from the generated set of cross venues. The orders are sent for execution at the scheduled cross venue at the scheduled cross time.

This application for letters patent disclosure document describes inventive aspects that include various novel innovations (hereinafter “disclosure”) and contains material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

### OTHER APPLICATIONS

Applications of interest include: U.S. patent application Ser. No. 14/611,219, filed Jan. 31, 2015, entitled “Registered Matching Services Apparatuses, Methods and Systems”, (attorney docket no. Fidelity0171US); U.S. patent application Ser. No. 15/065,805, filed Mar. 9, 2016, entitled “Asset Allotment Data Router Apparatuses, Methods and Systems”, (attorney docket no. Fidelity0222US).

The entire contents of the aforementioned applications are herein expressly incorporated by reference.

### FIELD

The present innovations generally address security, and more particularly, include Secret Key-Based Counterparty Matching Engine Apparatuses, Methods and Systems.

However, in order to develop a reader's understanding of the innovations, disclosures have been compiled into a single description to illustrate and clarify how aspects of these innovations operate independently, interoperate as between individual innovations, and/or cooperate collectively. The application goes on to further describe the interrelations and synergies as between the various innovations; all of which is to further compliance with 35 U.S.C.

### BACKGROUND

People own all types of assets, some of which are secured instruments to underlying assets. People have used exchanges to facilitate trading and selling of such assets. Computer information systems, such as NAICO-NET, Trade*Plus and E*Trade allowed owners to trade securities assets electronically.

### BRIEF DESCRIPTION OF THE DRAWINGS

Appendices and/or drawings illustrating various, non-limiting, example, innovative aspects of the Secret Key-Based Counterparty Matching Engine Apparatuses, Methods and Systems (hereinafter “SKCME”) disclosure, include:

FIG. 1 shows an architecture for the SKCME;

FIGS. 2A-B show a datagraph illustrating data flow(s) for the SKCME;

FIG. 3 shows a logic flow illustrating embodiments of a matched key generating (MKG) component for the SKCME;

FIG. 4 shows a logic flow illustrating embodiments of an order processing (OP) component for the SKCME;

FIG. 5 shows an architecture for the SKCME;

FIGS. 6A-D show a datagraph illustrating data flow(s) for the SKCME;

FIG. 7 shows a logic flow illustrating embodiments of a matched key generating (MKG) component for the SKCME;

FIG. 8 shows a logic flow illustrating embodiments of an order processing (OP) component for the SKCME;

FIG. 9 shows a logic flow illustrating embodiments of an order execution (OE) component for the SKCME;

FIG. 10 shows a logic flow illustrating embodiments of a compromise mitigating (CM) component for the SKCME;

FIG. 11 shows implementation case(s) for the SKCME;

FIG. 12 shows implementation case(s) for the SKCME;

FIG. 13 shows implementation case(s) for the SKCME;

FIG. 14 shows implementation case(s) for the SKCME;

FIG. 15 shows implementation case(s) for the SKCME;

FIG. 16 shows implementation case(s) for the SKCME;

FIGS. 17A-B show implementation case(s) for the SKCME;

FIG. 18 shows implementation case(s) for the SKCME;

FIG. 19 shows a block diagram illustrating embodiments of a SKCME controller.

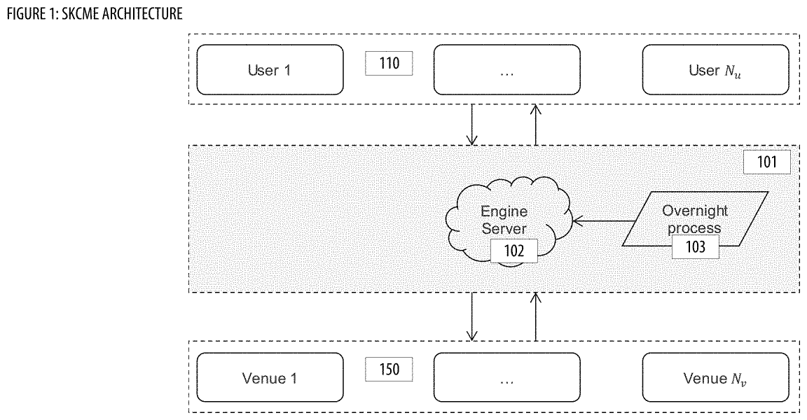

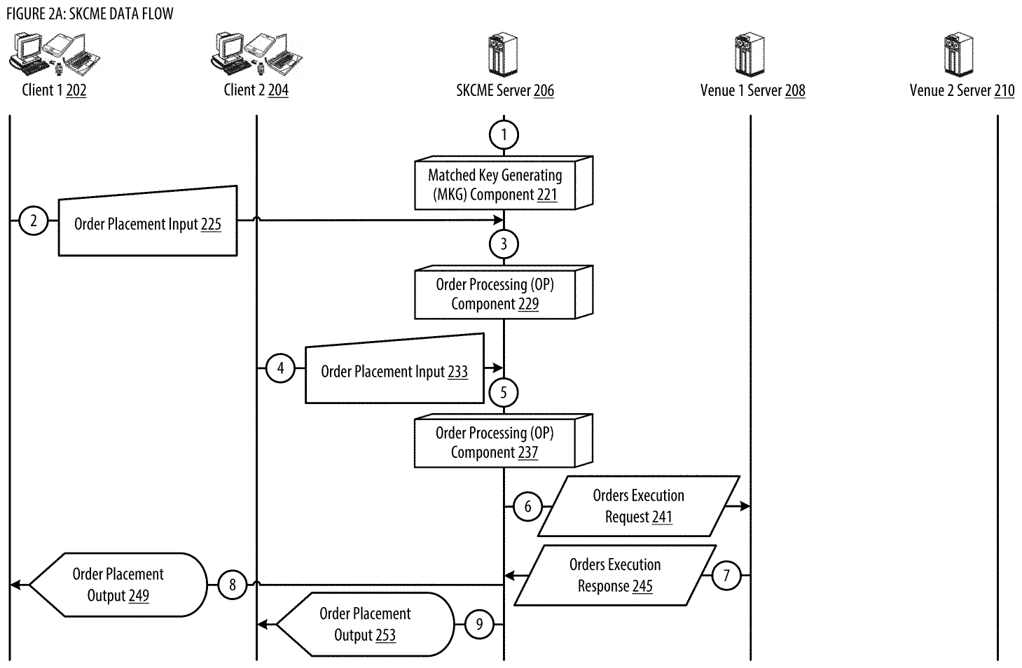

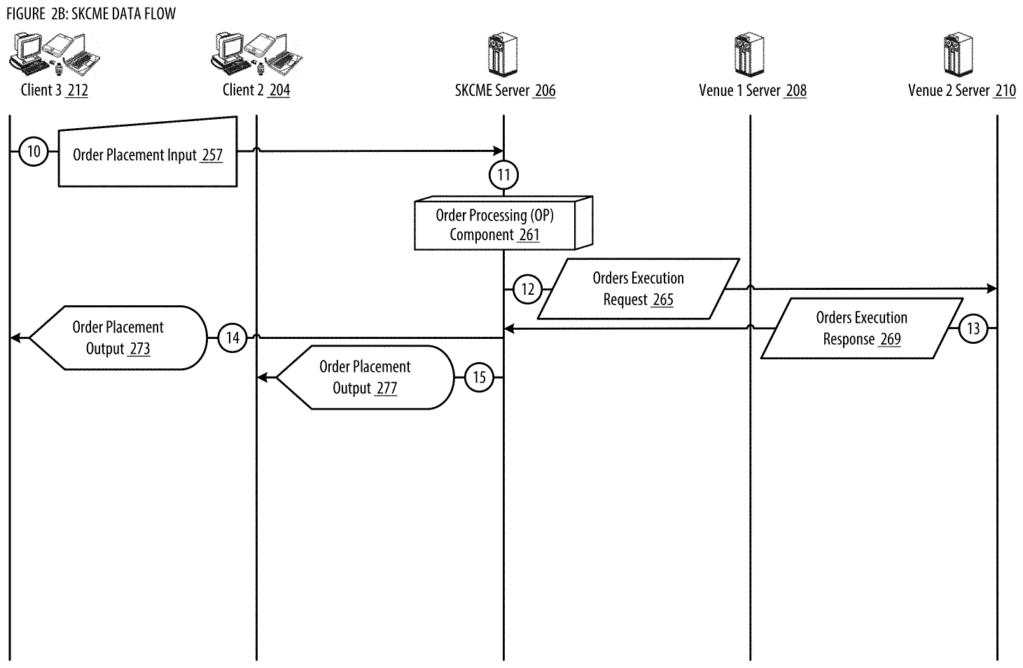

Generally, the leading number of each citation number within the drawings indicates the figure in which that citation number is introduced and/or detailed. As such, a detailed discussion of citation number 101 would be found and/or introduced in FIG. 1. Citation number 201 is introduced in FIG. 2, etc. Any citations and/or reference numbers are not necessarily sequences but rather just example orders that may be rearranged and other orders are contemplated. Citation number suffixes may indicate that an earlier introduced item has been re-referenced in the context of a later figure and may indicate the same item, evolved/modified version of the earlier introduced item, etc., e.g., server 199 of FIG. 1 may be a similar server 299 of FIG. 2 in the same and/or new context.

### DETAILED DESCRIPTION

The Secret Key-Based Counterparty Matching Engine Apparatuses, Methods and Systems (hereinafter “SKCME”) transforms client key message, order placement input inputs, via SKCME components (e.g., MKG, OP, OE, CM, etc. components), into order placement output outputs. The SKCME components, in various embodiments, implement advantageous features as set forth below.

### INTRODUCTION

The SKCME provides unconventional features (e.g., generating a secret matched key used to initialize the seed of a random number generator used to create a list of scheduled execution times and locations to synchronize matching across multiple counterparties) that were never before available in security.

Institutions have large trade quantity. They do not want others to know their trade intentions. Best trade outcome occurs if large buyers can discover large sellers. This eliminates profits that are captured by middleman, and avoids potential information leakage to other counterparties. Furthermore, institutions want to be able to trade across the day instead of at a single point in time. Trading across a longer duration enhances price discovery. The SKCME implements a methodology that allows institutions to match with each other at multiple times in a day without the need to disclose information between buyers and sellers.

In one embodiment, the SKCME generates a secret key that is converted to an integer to initialize the seed of a random generator. The random generator is used to create a list of scheduled execution times and locations. At the scheduled times, trading algorithms may send short-time peg/limit orders to designated locations to facilitate crosses for institutions.

### SKCME

FIG. 1 shows an architecture for the SKCME. In FIG. 1, an embodiment of how the SKCME may be utilized to facilitate secret key-based counterparty matching is illustrated. In one implementation, the SKCME 101 may include an engine server 102 and an overnight process 103. The overnight process may generate (e.g., precompute before market opens) cross info (e.g., sets of matched keys, cross times, cross venues, and/or the like) to be used by the engine server to match counterparties, such as users 1-Nᵤ 110. When the engine server receives orders for a security from the users, the engine server uses the cross info to determine the next scheduled time when the orders should be sent, and, at the next scheduled time, sends the orders to the next scheduled venue, from venues 1-Nᵥ 150, for execution.

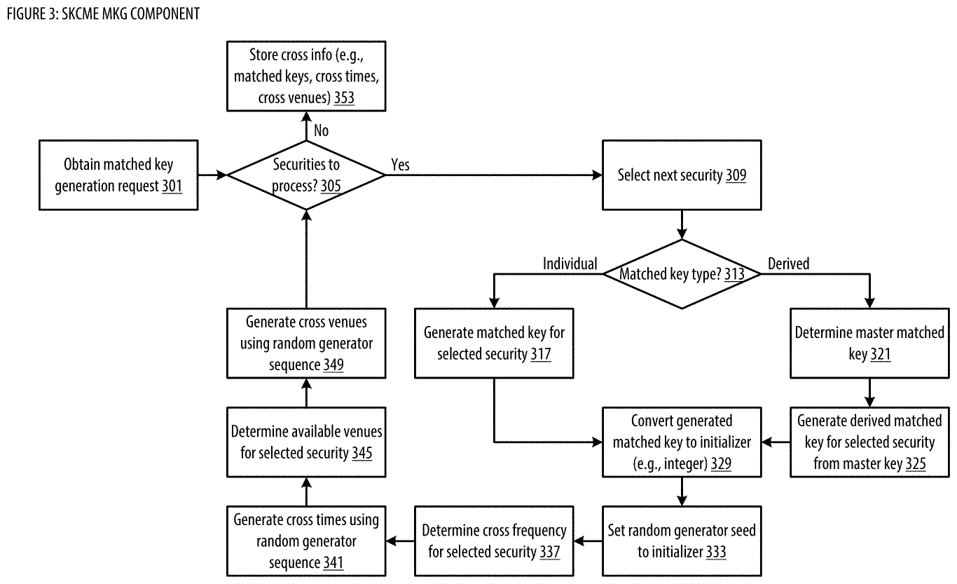

FIGS. 2A-B show a datagraph illustrating data flow(s) for the SKCME. In FIGS. 2A-B, a matched key generating (MKG) component 221 may generate (e.g., generate dynamically at order arrival, precompute before market opens) cross info (e.g., sets of matched keys, cross times, cross venues, and/or the like) to facilitate matching counterparties. See FIG. 3 for additional details regarding the MKG component.

Client 1 202 (e.g., of a first counterparty) may send an order placement input 225 to a SKCME server 206 to facilitate placing an order (e.g., a buy order) for a security. For example, client 1 may be a desktop, a laptop, a tablet, a smartphone, a smartwatch, and/or the like that is executing a client application. In one implementation, the order placement input may include data such as a request identifier, an order type, a security identifier, a quantity, an execution algorithm identifier, and/or the like. In one embodiment, client 1 may provide the following example order placement input, substantially in the form of a (Secure) Hypertext Transfer Protocol (“HTTP(S)”) POST message including eXtensible Markup Language (“XML”) formatted data, as provided below:

POST /authrequest.php HTTP/1.1
Host: www.server.com
Content-Type: Application/XML
Content-Length: 667
<?XML version = “1.0” encoding = “UTF-8”?>
<auth_request>

<timestamp>2020-12-31 09:30:01</timestamp>
<user_accounts_details>

<user_account_credentials>

<user_name>JohnDaDoeDoeDoooe@gmail.com</user_name>
<password>abc123</password>
//OPTIONAL <cookie>cookieID</cookie>
//OPTIONAL <digital_cert_link>www.mydigitalcertificate.com/

JohnDoeDaDoeDoe@gmail.com/mycertifcate.dc</digital_cert_link>

//OPTIONAL <digital_certificate>_DATA_</digital_certificate>

</user_account_credentials>

</user_accounts_details>
<client_details> //iOS Client with App and Webkit

//it should be noted that although several client details
//sections are provided to show example variants of client
//sources, further messages will include only on to save
//space

<client_IP>10.0.0.123</client_IP>
<user_agent_string>Mozilla/5.0 (iPhone; CPU iPhone OS 7_1_1 like Mac OS X)

AppleWebKit/537.51.2 (KHTML, like Gecko) Version/7.0 Mobile/11D201
Safari/9537.53</user_agent_string>

<client_product_type>iPhone6,1</client_product_type>
<client_serial_number>DNXXX1X1XXXX</client_serial_number>
<client_UDID>3XXXXXXXXXXXXXXXXXXXXXXXXD</client_UDID>
<client_OS>iOS</client_OS>
<client_OS_version>7.1.1</client_OS_version>
<client_app_type>app with webkit</client_app_type>
<app_installed_flag>true</app_installed_flag>
<app_name>SKCME.app</app_name>
<app_version>1.0 </app_version>
<app_webkit_name>Mobile Safari</client_webkit_name>
<client_version>537.51.2</client_version>

</client_details>
<client_details> //iOS Client with Webbrowser

<client_IP>10.0.0.123</client_IP>
<user_agent_string>Mozilla/5.0 (iPhone; CPU iPhone OS 7_1_1 like Mac OS X)

AppleWebKit/537.51.2 (KHTML, like Gecko) Version/7.0 Mobile/11D201
Safari/9537.53</user_agent_string>

<client_product_type>iPhone6,1</client_product_type>
<client_serial_number>DNXXX1X1XXXX</client_serial_number>
<client_UDID>3XXXXXXXXXXXXXXXXXXXXXXXXD</client_UDID>
<client_OS>iOS</client_OS>
<client_OS_version>7.1.1</client_OS_version>
<client_app_type>web browser</client_app_type>
<client_name>Mobile Safari</client_name>
<client_version>9537.53</client_version>

</client_details>
<client_details> //Android Client with Webbrowser

<client_IP>10.0.0.123</client_IP>
<user_agent_string>Mozilla/5.0 (Linux; U; Android 4.0.4; en-us; Nexus S

Build/IMM76D) AppleWebKit/534.30 (KHTML, like Gecko) Version/4.0 Mobile
Safari/534.30</user_agent_string>

<client_product_type>Nexus S</client_product_type>
<client_serial_number>YXXXXXXXXZ</client_serial_number>
<client_UDID>FXXXXXXXXX-XXXX-XXXX-XXXX-XXXXXXXXXXXXX</client_UDID>
<client_OS>Android</client_OS>
<client_OS_version>4.0.4</client_OS_version>
<client_app_type>web browser</client_app_type>
<client_name>Mobile Safari</client_name>
<client_version>534.30</client_version>

</client_details>
<client_details> //Mac Desktop with Webbrowser

<client_IP>10.0.0.123</client_IP>
<user_agent_string>Mozilla/5.0 (Macintosh; Intel Mac OS X 10_9_3)

AppleWebKit/537.75.14 (KHTML, like Gecko) Version/7.0.3
Safari/537.75.14</user_agent_string>

<client_product_type>MacPro5,1</client_product_type>
<client_serial_number>YXXXXXXXXZ</client_serial_number>
<client_UDID>FXXXXXXXXX-XXXX-XXXX-XXXX-XXXXXXXXXXXXX</client_UDID>
<client_OS>Mac OS X</client_OS>
<client_OS_version>10.9.3</client_OS_version>
<client_app_type>web browser</client_app_type>
<client_name>Mobile Safari</client_name>
<client_version>537.75.14</client_version>

</client_details>
<order_placement_input>

<request_identifier>ID_request_1</request_identifier>
<order_type>BUY</order_type>
<security_identifier>AAPL</security_identifier>
<order_quantity>100,000</order_quantity>

</order_placement_input>

</auth_request>

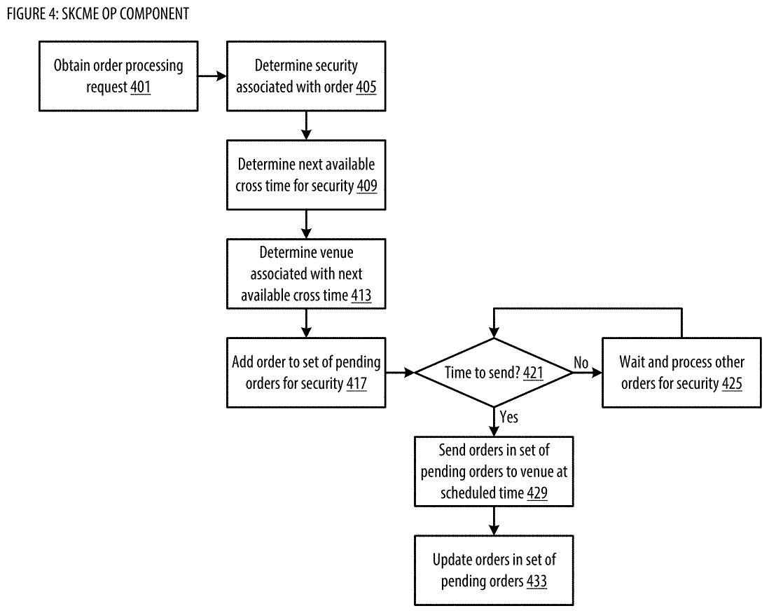

An order processing (OP) component 229 may utilize data provided in order placement inputs to facilitate sending pending orders at a scheduled cross time to a scheduled cross venue. See FIG. 4 for additional details regarding the OP component.

Client 2 204 (e.g., of a second counterparty) may send an order placement input 233 to the SKCME server 206 to facilitate placing an order (e.g., a sell order) for the security. For example, client 2 may be a desktop, a laptop, a tablet, a smartphone, a smartwatch, and/or the like that is executing a client application. In one implementation, the order placement input may include data such as a request identifier, an order type, a security identifier, a quantity, an execution algorithm identifier, and/or the like. In one embodiment, client 2 may provide the following example order placement input, substantially in the form of a HTTP(S) POST message including XML-formatted data, as provided below:

POST /authrequest.php HTTP/1.1
Host: www.server.com
Content-Type: Application/XML
Content-Length: 667
<?XML version = “1.0” encoding = “UTF-8”?>
<auth_request>

<timestamp>2020-12-31 09:30:02</timestamp>
<user_accounts_details>

<user_account_credentials>

<user_name>BobDaDoeDoeDoooe@gmail.com</user_name>
<password>def456</password>
//OPTIONAL <cookie>cookieID</cookie>
//OPTIONAL <digital_cert_link>www.mydigitalcertificate.com/

BobDoeDaDoeDoe@gmail.com/mycertifcate.dc</digital_cert_link>

//OPTIONAL <digital_certificate>_DATA_</digital_certificate>

</user_account_credentials>

</user_accounts_details>
<client_details> //iOS Client with App and Webkit

//it should be noted that although several client details
//sections are provided to show example variants of client
//sources, further messages will include only on to save
//space

<client_IP>10.0.0.124</client_IP>
<user_agent_string>Mozilla/5.0 (iPhone; CPU iPhone OS 7_1_1 like Mac OS X)

AppleWebKit/537.51.2 (KHTML, like Gecko) Version/7.0 Mobile/11D201
Safari/9537.53</user_agent_string>

<client_product_type>iPhone6,1</client_product_type>
<client_serial_number>DNXXX1X1XXXX</client_serial_number>
<client_UDID>3XXXXXXXXXXXXXXXXXXXXXXXXD</client_UDID>
<client_OS>iOS</client_OS>
<client_OS_version>7.1.1</client_OS_version>
<client_app_type>app with webkit</client_app_type>
<app_installed_flag>true</app_installed_flag>
<app_name>SKCME.app</app_name>
<app_version>1.0 </app_version>
<app_webkit_name>Mobile Safari</client_webkit_name>
<client_version>537.51.2</client_version>

</client_details>
<client_details> //iOS Client with Webbrowser

<client_IP>10.0.0.124</client_IP>
<user_agent_string>Mozilla/5.0 (iPhone; CPU iPhone OS 7_1_1 like Mac OS X)

AppleWebKit/537.51.2 (KHTML, like Gecko) Version/7.0 Mobile/11D201
Safari/9537.53</user_agent_string>

<client_product_type>iPhone6,1</client_product_type>
<client_serial_number>DNXXX1X1XXXX</client_serial_number>
<client_UDID>3XXXXXXXXXXXXXXXXXXXXXXXXD</client_UDID>
<client_OS>iOS</client_OS>
<client_OS_version>7.1.1</client_OS_version>
<client_app_type>web browser</client_app_type>
<client_name>Mobile Safari</client_name>
<client_version>9537.53</client_version>

</client_details>
<client_details> //Android Client with Webbrowser

<client_IP>10.0.0.124</client_IP>
<user_agent_string>Mozilla/5.0 (Linux; U; Android 4.0.4; en-us; Nexus S

Build/IMM76D) AppleWebKit/534.30 (KHTML, like Gecko) Version/4.0 Mobile
Safari/534.30</user_agent_string>

<client_product_type>Nexus S</client_product_type>
<client_serial_number>YXXXXXXXXZ</client_serial_number>
<client_UDID>FXXXXXXXXX-XXXX-XXXX-XXXX-XXXXXXXXXXXXX</client_UDID>
<client_OS>Android</client_OS>
<client_OS_version>4.0.4</client_OS_version>
<client_app_type>web browser</client_app_type>
<client_name>Mobile Safari</client_name>
<client_version>534.30</client_version>

</client_details>
<client_details> //Mac Desktop with Webbrowser

<client_IP>10.0.0.124</client_IP>
<user_agent_string>Mozilla/5.0 (Macintosh; Intel Mac OS X 10_9_3)

AppleWebKit/537.75.14 (KHTML, like Gecko) Version/7.0.3
Safari/537.75.14</user_agent_string>

<client_product_type>MacPro5,1</client_product_type>
<client_serial_number>YXXXXXXXXZ</client_serial_number>
<client_UDID>FXXXXXXXXX-XXXX-XXXX-XXXX-XXXXXXXXXXXXX</client_UDID>
<client_OS>Mac OS X</client_OS>
<client_OS_version>10.9.3</client_OS_version>
<client_app_type>web browser</client_app_type>
<client_name>Mobile Safari</client_name>
<client_version>537.75.14</client_version>

</client_details>
<order_placement_input>

<request_identifier>ID_request_2</request_identifier>
<order_type>SELL</order_type>
<security_identifier>AAPL</security_identifier>
<order_quantity>200,000</order_quantity>

</order_placement_input>

</auth_request>

An order processing (OP) component 237 may utilize data provided in order placement inputs to facilitate sending pending orders at a scheduled cross time to a scheduled cross venue. See FIG. 4 for additional details regarding the OP component.

The SKCME server 206 may send an orders execution request 241 to venue 1 server 208 to facilitate execution of pending orders. In one implementation, the orders execution request may include data such as a request identifier, orders data, and/or the like. In one embodiment, the SKCME server may provide the following example orders execution request, substantially in the form of a HTTP(S) POST message including XML-formatted data, as provided below:

POST /orders_execution_request.php HTTP/1.1
Host: www.server.com
Content-Type: Application/XML
Content-Length: 667
<?XML version = “1.0” encoding = “UTF-8”?>
<orders_execution_request>

<request_identifier>ID_request_3</request_identifier>
<orders>

<order>

<order_identifier>ID_order_1</order_identifier>
<order_type>BUY</order_type>
<security_identifier>AAPL</security_identifier>
<order_quantity>100,000</order_quantity>

</order>
<order>

<order_identifier>ID_order_2</order_identifier>
<order_type>SELL</order_type>
<security_identifier>AAPL</security_identifier>
<order_quantity>200,000</order_quantity>

</order>
...

</orders>

</orders_execution_request>

Venue 1 server 208 may send an orders execution response 245 to the SKCME server 206 to inform the SKCME server whether the orders were executed successfully. In one implementation, the orders execution response may include data such as a response identifier, orders status data, and/or the like. In one embodiment, venue 1 server may provide the following example orders execution response, substantially in the form of a HTTP(S) POST message including XML-formatted data, as provided below:

POST /orders_execution_response.php HTTP/1.1
Host: www.server.com
Content-Type: Application/XML
Content-Length: 667
<?XML version = “1.0” encoding = “UTF-8”?>
<orders_execution_response>

<response_identifier>ID_response_3</response_identifier>
<orders>

<order>

<order_identifier>ID_order_1</order_identifier>
<order_status>FILLED</order_status>

</order>
<order>

<order_identifier>ID_order_2</order_identifier>
<order_status>PARTIALLY_FILLED</order_status>
<quantity_filled>100,000</quantity_filled>

</order>
...

</orders>

</orders_execution_response>

The SKCME server 206 may send an order placement output 249 to client 1 202 to inform the first counterparty regarding the status of the first counterparty's order. In one implementation, the order placement output may include data such as a response identifier, a status, and/or the like. In one embodiment, the SKCME server may provide the following example order placement output, substantially in the form of a HTTP(S) POST message including XML-formatted data, as provided below:

POST /order_placement_output.php HTTP/1.1
Host: www.server.com
Content-Type: Application/XML
Content-Length: 667
<?XML version = “1.0” encoding = “UTF-8”?>
<order_placement_output>

<response_identifier>ID_response_1</response_identifier>
<order_status>FILLED</order_status>

</order_placement_output>

The SKCME server 206 may send an order placement output 253 to client 2 204 to inform the second counterparty regarding the status of the second counterparty's order. In one implementation, the order placement output may include data such as a response identifier, a status, and/or the like. In one embodiment, the SKCME server may provide the following example order placement output, substantially in the form of a HTTP(S) POST message including XML-formatted data, as provided below:

POST /order_placement_output.php HTTP/1.1
Host: www.server.com
Content-Type: Application/XML
Content-Length: 667
<?XML version = “1.0” encoding = “UTF-8”?>
<order_placement_output>

<response_identifier>ID_response_2a</response_identifier>
<order_status>PARTIALLY_FILLED</order_status>
<quantity_filled>100,000</quantity_filled>

</order_placement_output>

Client 3 212 (e.g., of a third counterparty) may send an order placement input 257 to the SKCME server 206 to facilitate placing an order (e.g., a buy order) for the security. For example, client 3 may be a desktop, a laptop, a tablet, a smartphone, a smartwatch, and/or the like that is executing a client application. In one implementation, the order placement input may include data such as a request identifier, an order type, a security identifier, a quantity, an execution algorithm identifier, and/or the like. In one embodiment, client 3 may provide the following example order placement input, substantially in the form of a HTTP(S) POST message including XML-formatted data, as provided below:

POST /authrequest.php HTTP/1.1
Host: www.server.com
Content-Type: Application/XML
Content-Length: 667
<?XML version = “1.0” encoding = “UTF-8”?>
<auth_request>

<timestamp>2020-12-31 09:31:01</timestamp>
<user_accounts_details>

<user_account_credentials>

<user_name>AliceDaDoeDoeDoooe@gmail.com</user_name>
<password>ghi789</password>
//OPTIONAL <cookie>cookieID</cookie>
//OPTIONAL <digital_cert_link>www.mydigitalcertificate.com/

AliceDoeDaDoeDoe@gmail.com/mycertifcate.dc</digital_cert_link>

//OPTIONAL <digital_certificate>_DATA_</digital_certificate>

</user_account_credentials>

</user_accounts_details>
<client_details> //iOS Client with App and Webkit

//it should be noted that although several client details
//sections are provided to show example variants of client
//sources, further messages will include only on to save
//space

<client_IP>10.0.0.125</client_IP>
<user_agent_string>Mozilla/5.0 (iPhone; CPU iPhone OS 7_1_1 like Mac OS X)

AppleWebKit/537.51.2 (KHTML, like Gecko) Version/7.0 Mobile/11D201
Safari/9537.53</user_agent_string>

<client_product_type>iPhone6,1</client_product_type>
<client_serial_number>DNXXX1X1XXXX</client_serial_number>
<client_UDID>3XXXXXXXXXXXXXXXXXXXXXXXXD</client_UDID>
<client_OS>iOS</client_OS>
<client_OS_version>7.1.1</client_OS_version>
<client_app_type>app with webkit</client_app_type>
<app_installed_flag>true</app_installed_flag>
<app_name>SKCME.app</app_name>
<app_version>1.0 </app_version>
<app_webkit_name>Mobile Safari</client_webkit_name>
<client_version>537.51.2</client_version>

</client_details>
<client_details> //iOS Client with Webbrowser

<client_IP>10.0.0.125</client_IP>
<user_agent_string>Mozilla/5.0 (iPhone; CPU iPhone OS 7_1_1 like Mac OS X)

AppleWebKit/537.51.2 (KHTML, like Gecko) Version/7.0 Mobile/11D201
Safari/9537.53</user_agent_string>

<client_product_type>iPhone6,1</client_product_type>
<client_serial_number>DNXXX1X1XXXX</client_serial_number>
<client_UDID>3XXXXXXXXXXXXXXXXXXXXXXXXD</client_UDID>
<client_OS>iOS</client_OS>
<client_OS_version>7.1.1</client_OS_version>
<client_app_type>web browser</client_app_type>
<client_name>Mobile Safari</client_name>
<client_version>9537.53</client_version>

</client_details>
<client_details> //Android Client with Webbrowser

<client_IP>10.0.0.125</client_IP>
<user_agent_string>Mozilla/5.0 (Linux; U; Android 4.0.4; en-us; Nexus S

Build/IMM76D) AppleWebKit/534.30 (KHTML, like Gecko) Version/4.0 Mobile
Safari/534.30</user_agent_string>

<client_product_type>Nexus S</client_product_type>
<client_serial_number>YXXXXXXXXZ</client_serial_number>
<client_UDID>FXXXXXXXXX-XXXX-XXXX-XXXX-XXXXXXXXXXXXX</client_UDID>
<client_OS>Android</client_OS>
<client_OS_version>4.0.4</client_OS_version>
<client_app_type>web browser</client_app_type>
<client_name>Mobile Safari</client_name>
<client_version>534.30</client_version>

</client_details>
<client_details> //Mac Desktop with Webbrowser

<client_IP>10.0.0.125</client_IP>
<user_agent_string>Mozilla/5.0 (Macintosh; Intel Mac OS X 10_9_3)

AppleWebKit/537.75.14 (KHTML, like Gecko) Version/7.0.3
Safari/537.75.14</user_agent_string>

<client_product_type>MacPro5,1</client_product_type>
<client_serial_number>YXXXXXXXXZ</client_serial_number>
<client_UDID>FXXXXXXXXX-XXXX-XXXX-XXXX-XXXXXXXXXXXXX</client_UDID>
<client_OS>Mac OS X</client_OS>
<client_OS_version>10.9.3</client_OS_version>
<client_app_type>web browser</client_app_type>
<client_name>Mobile Safari</client_name>
<client_version>537.75.14</client_version>

</client_details>
<order_placement_input>

<request_identifier>ID_request_4</request_identifier>
<order_type>BUY</order_type>
<security_identifier>AAPL</security_identifier>
<order_quantity>150,000</order_quantity>

</order_placement_input>

</auth_request>

An order processing (OP) component 261 may utilize data provided in order placement inputs to facilitate sending pending orders at a subsequent scheduled cross time to a subsequent scheduled cross venue. See FIG. 4 for additional details regarding the OP component.

The SKCME server 206 may send an orders execution request 265 to venue 2 server 210 to facilitate execution of pending orders (e.g., including the third counterparty's order and the unfilled portion of the second counterparty's order). In one implementation, the orders execution request may include data such as a request identifier, orders data, and/or the like. In one embodiment, the SKCME server may provide the following example orders execution request, substantially in the form of a HTTP(S) POST message including XML-formatted data, as provided below:

POST /orders_execution_request.php HTTP/1.1
Host: www.server.com
Content-Type: Application/XML
Content-Length: 667
<?XML version = “1.0” encoding = “UTF-8”?>
<orders_execution_request>

<request_identifier>ID_request_5</request_identifier>
<orders>

<order>

<order_identifier>ID_order_3</order_identifier>
<order_type>BUY</order_type>
<security_identifier>AAPL</security_identifier>
<order_quantity>150,000</order_quantity>

</order>
<order>

<order_identifier>ID_order_2</order_identifier>
<order_type>SELL</order_type>
<security_identifier>AAPL</security_identifier>
<order_quantity>100,000</order_quantity>

</order>
...

</orders>

</orders_execution_request>

Venue 2 server 210 may send an orders execution response 269 to the SKCME server 206 to inform the SKCME server whether the orders were executed successfully. In one implementation, the orders execution response may include data such as a response identifier, orders status data, and/or the like. In one embodiment, venue 2 server may provide the following example orders execution response, substantially in the form of a HTTP(S) POST message including XML-formatted data, as provided below:

POST /orders_execution_response.php HTTP/1.1
Host: www.server.com
Content-Type: Application/XML
Content-Length: 667
<?XML version = “1.0” encoding = “UTF-8”?>
<orders_execution_response>

<response_identifier>ID_response_5</response_identifier>
<orders>

<order>

<order_identifier>ID_order_3</order_identifier>
<order_status>PARTIALLY_FILLED</order_status>
<quantity_filled>100,000</quantity_filled>

</order>
<order>

<order_identifier>ID_order_2</order_identifier>
<order_status>FILLED</order_status>

</order>
...

</orders>

</orders_execution_response>

The SKCME server 206 may send an order placement output 273 to client 3 212 to inform the third counterparty regarding the status of the third counterparty's order. In one implementation, the order placement output may include data such as a response identifier, a status, and/or the like. In one embodiment, the SKCME server may provide the following example order placement output, substantially in the form of a HTTP(S) POST message including XML-formatted data, as provided below:

POST /order_placement_output.php HTTP/1.1
Host: www.server.com
Content-Type: Application/XML
Content-Length: 667
<?XML version = “1.0” encoding = “UTF-8”?>
<order_placement_output>

<response_identifier>ID_response_4</response_identifier>
<order_status>PARTIALLY_FILLED</order_status>
<quantity_filled>100,000</quantity_filled>

</order_placement_output>

The SKCME server 206 may send an order placement output 277 to client 2 204 to inform the second counterparty regarding the status of the second counterparty's order. In one implementation, the order placement output may include data such as a response identifier, a status, and/or the like. In one embodiment, the SKCME server may provide the following example order placement output, substantially in the form of a HTTP(S) POST message including XML-formatted data, as provided below:

POST /order_placement_output.php HTTP/1.1
Host: www.server.com
Content-Type: Application/XML
Content-Length: 667
<?XML version = “1.0” encoding = “UTF-8”?>
<order_placement_output>

<response_identifier>ID_response_2b</response_identifier>
<order_status>FILLED</order_status>

</order_placement_output>

FIG. 3 shows a logic flow illustrating embodiments of a matched key generating (MKG) component for the SKCME. In FIG. 3, a matched key generation request may be obtained at 301. For example, the matched key generation request may be obtained as a result of running an overnight process to generate cross info (e.g., sets of matched keys, cross times, cross venues, and/or the like). In another example, the matched key generation request may be obtained as a result of an order arrival to dynamically generate cross info for securities associated with the order. It is to be understood that, in some embodiments, instead of generating different cross info for each security, global cross info may be generated for securities.

A determination may be made at 305 whether there remain securities to process. In one implementation, each of the securities (e.g., securities in the universe of covered securities, such as equities; securities associated with the order) may be processed. If there remain securities to process, the next security may be selected for processing at 309.

A determination may be made at 313 regarding the matched key type to utilize (e.g., based on a configuration setting). If an individual matched key should be utilized, a matched key for the selected security may be generated at 317. For example, the matched key may be a secret key in the form of a data structure such as a string, a number, a custom data type, and/or the like. In one implementation, the matched key may be created by generating a private cryptographic key (e.g., a number, a custom data type) associated with the selected security. In another implementation, the matched key may be created by generating a value (e.g., a string) associated with the selected security (e.g., a phrase, such as “secret room”; a concatenation of the selected security's ticker and a random number).

If a derived matched key should be utilized, a master matched key may be determined at 321. For example, instead of generating completely different matched keys for each security, a master matched key may be used (e.g., for a specified duration, such as a day) to generate derived matched keys for each security. In one implementation, the master matched key may be created by generating a private cryptographic key (e.g., a number, a custom data type). In another implementation, the master matched key may be a created by generating a value (e.g., a string, such as “Fibonacci Numbers”). A derived matched key for the selected security may be generated from the master matched key at 325. In one implementation, the derived matched key may be generated using a concatenation method. For example, derived matched keys may be created as follows:
Master Key=“Fibonacci Numbers”
Derived Keys
AAPL=“Fibonacci Numbers AAPL”
IBM=“Fibonacci Numbers IBM”
FB=“Fibonacci Numbers FB”
   In another implementation, the derived matched key may be generated using a modulo sum method (e.g., using modulo 2147438648 of the sum). For example, derived matched keys may be created as follows:
Master Key=“Fibonacci Numbers”
Derived Keys
AAPL=“Fibonacci Numbers”+“AAPL”
IBM=“Fibonacci Numbers”+“IBM”
FB=“Fibonacci Numbers”+“FB”

The generated matched key for the selected security may be converted to an initializer (e.g., an integer initializer) at 329. In one implementation, a conversion calculation similar to the following may be utilized (e.g., using the Q query language for kdb+):
Conversion Calculation
{‘int$x mod 2147483648} {sum x*16 xexp til count x} 15#first 16 vs md5 matched_key
   For example, an individual matched key may be converted to an initializer using the conversion calculation as follow:
Exemplary Results
“secret room”→670625152
“finding others”→1899251328
“i don't want to know”→1258907392
   In another example, a derived matched key generated using a concatenation method may be converted to an initializer using the conversion calculation (e.g., for the concatenated string) as follow:
Exemplary Results
AAPL=“Fibonacci Numbers AAPL”→1263182720
IBM=“Fibonacci Numbers IBM”→1464810592
FB=“Fibonacci Numbers FB”→493988352
   In another example, a derived matched key generated using a modulo sum method (e.g., using modulo 2147438648 of the sum) may be converted to an initializer using the conversion calculation (e.g., for each individual string portion) as follow:
Exemplary Results
AAPL=“Fibonacci Numbers”+“AAPL”→(1971600128+99199232) mod 2147438648=2070799360
IBM=“Fibonacci Numbers”+“IBM”→(1971600128+1833767984) mod 2147438648=1657884464
FB=“Fibonacci Numbers”+“FB”→(1971600128+603721280) mod 2147438648=427837760

A random generator seed of a random number generator may be set to the initializer at 333. For example, the random generator seed of the random number generator may be set to the initializer as follows:
Setseed[670625152]

A cross frequency for the selected security may be determined at 337. In one implementation, the cross frequency (e.g., the number of scheduled execution times that may be used for the selected security per day) may be specified in a configuration setting. For example, a cross frequency of 390 crosses per day may be utilized (e.g., one cross per minute during the 6.5 hours during which the markets are open). In another implementation, the cross frequency may be generated using the random number generator.

Cross times may be generated using a sequence from the random number generator at 341. In one implementation, a cross time (e.g., one cross time per minute) may be generated (e.g., with timestamp accuracy out to the millisecond) for each cross frequency period (e.g., one minute—the cross frequency period may be calculated, in minutes, as 390 divided by the cross frequency). For example, the cross times may be calculated as follows:
Exemplary Calculation
crosstime: 09:30:00.000+(60000*til 390)+390?60000
Exemplary Results
09:30:51.941 09:31:14.173 09:32:10.836 09:33:29.935 09:34:06.429 09:35:02.321 . . .

In another implementation, the cross times may be generated using exponential distribution between time. For example, the cross times may be calculated as follows:
Exemplary Calculation
crosstime: 09:30:00.000+‘int$sums neg 60000*(log 390?1f)
Exemplary Results
09:30:01.795 09:30:50.432 09:32:19.033 09:34:06.054 09:34:52.926 09:35:29.389 . . .

Available venues for the selected security may be determined at 345. For example, the available venues may be stock exchanges, dark pools, and/or the like where the selected security may be traded. In one implementation, a database may be queried to determine the number of available venues for the selected security. For example, the number of available venues (e.g., 10 venues) for the selected security may be determined via a MySQL database command similar to the following:

SELECT COUNT(venue)
FROM market_data
WHERE asset_ID = “AAPL”;

Cross venues may be generated using a sequence from the random number generator at 349. In one implementation, a cross venue (e.g., 0=NYSE, 1=NASDAQ, 2=a dark pool, etc.), may be generated for each cross time (e.g., one cross venue per minute). For example, the cross venues may be calculated as follows:
Exemplary Calculation
crossvenue: 390?10//assume there are 10 available venues
Exemplary Results
9 5 7 5 3 9 7 1 1 0 4 0 1 6 8 5 7 6 6 9 4 9 4 4 7 8 4 6 3 2 0 3 6 2 7 9 2 1 9 . . .

Cross info (e.g., matched keys, cross times, cross venues) may be stored at 353. In one implementation, the cross info for the securities may be stored in a database (e.g., in cross_info table 1919j).

FIG. 4 shows a logic flow illustrating embodiments of an order processing (OP) component for the SKCME. In FIG. 4, an order processing request may be obtained at 401. For example, the order processing request may be obtained as a result of an order arrival from a client (e.g., via an order placement input) to facilitate execution of the order.

A security associated with the order may be determined at 405. In one implementation, the order processing request may be parsed (e.g., using PHP commands) to determine the security identifier of the security (e.g., based on the value of the security_identifier field). It is to be understood that, in some embodiments, a plurality of securities and/or instructions (e.g., buy securities; sell securities) may be associated with the order and processed by the OP component.

The next available cross time for the security may be determined at 409. For example, the next available cross time may indicate when the order for the security should be sent for execution. In one implementation, the next available cross time may be determined by querying a database to determine cross times for the security and selecting the appropriate cross time based on the current time. For example, cross times for the security may be determined via a MySQL database command similar to the following:

SELECT assetCrossTimes
FROM cross_info
WHERE asset_ID = “AAPL”;

A venue associated with the next available cross time may be determined at 413. For example, the venue may indicate where (e.g., a stock exchange, a dark pool) the order for the security should be sent for execution. In one implementation, the venue may be determined by querying a database to determine venues for the security and selecting the venue corresponding to the next available cross time (e.g., based on sequence position, such as the 5^{th} venue for the 5^{th} cross time). For example, venues for the security may be determined via a MySQL database command similar to the following:
SELECT assetCrossVenues

FROM cross_info
WHERE asset_ID = “AAPL”;

The order may be added to a set of pending orders for the security at 417. For example, the set of pending orders for the security may include various orders (e.g., buy orders; sell orders) from various counterparties (e.g., approved to use the SKCME) that should be sent for execution at the next available cross time. In one implementation, the set of pending orders may be implemented as a linked list, array, etc. of order data structures (e.g., having data fields corresponding to data in the order field of an orders execution request).

A determination may be made at 421 whether it is time to send the orders in the set of pending orders for the security. In one implementation, the orders may be sent at the next available cross time. In another implementation, the orders may be sent some specified time (e.g., configured per venue) before the next available cross time to account for latency associated with transmitting the orders for execution.

If it is not yet time to send the orders for execution, the OP component may wait and process other orders for the security at 425. For example, the OP component may process order placement input 225 from client 1 202 and order placement input 233 from client 2 204 before sending these two orders for execution.

If it is time to send the orders for execution, the orders in the set of pending orders may be sent to the venue at the scheduled time at 429. For example, the orders may be sent via one or more orders execution requests. In one embodiment, an orders execution request specifying a plurality of orders may be sent. In another embodiment, a separate orders execution request may be sent for each order. In one implementation, an order may be sent as a short-term (e.g., typically less than 1 second) peg mid or limit order.

The orders in the set of pending orders may be updated at 433. In one implementation, if an order was filled, the order datastructure corresponding to the order may be removed from the set of pending orders. In another implementation, if an order was partially filled, the order datastructure corresponding to the order may be updated so that the order_quantity field reflects the remaining quantity to be filled (e.g., if an order to sell 200,000 shares of AAPL was received, and 100,000 shares were sold, the order_quantity field may be updated to 100,000 to reflect the number of shares remaining to be sold).

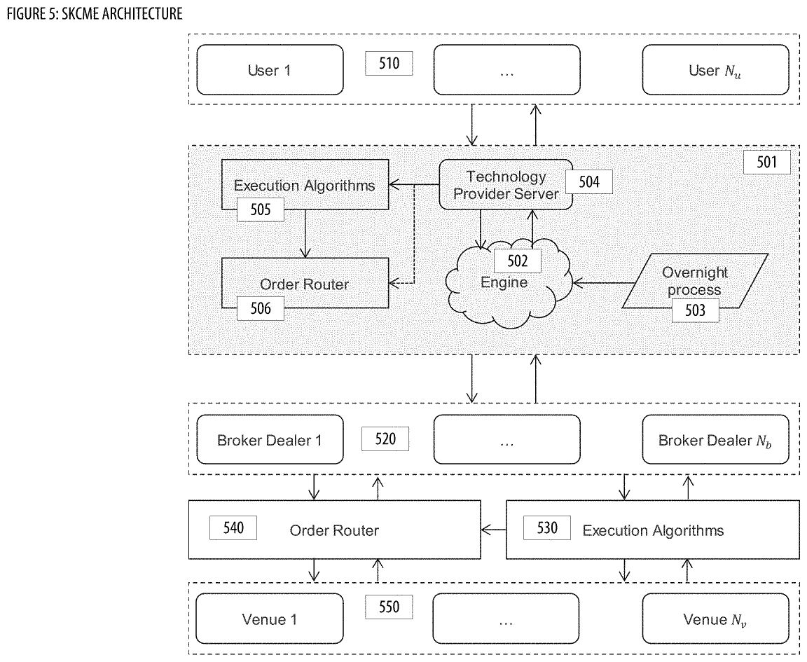

FIG. 5 shows an architecture for the SKCME. In FIG. 5, an embodiment of how the SKCME may be utilized to facilitate secret key-based counterparty matching is illustrated. In one implementation, the SKCME 501 may include an engine 502, an overnight process 503, a technology provider server 504, execution algorithms 505 and an order router 506. The overnight process may generate (e.g., precompute before market opens) cross info (e.g., sets of matched keys, cross times, cross venue, and/or the like) to be used by the engine to match counterparties, such as users 1-Nᵤ 510. When the technology provider server receives an order for a security from a user, the technology provider server may process the order using an execution algorithm or the order router.

If the order is an algorithmic order, the technology provider server may initialize the order using the specified execution algorithm. The execution algorithm may obtain cross times and/or cross venues for the security from the engine, and may determine the next scheduled time when the order should be sent. At the scheduled time, the execution algorithm may check any additional criteria (e.g., price, liquidity, demand, schedule, urgency, and/or the like) and, if the additional criteria are satisfied, may send the order to the order router with the next scheduled venue, from venues 1-Nᵥ 550, specified in a particular field (e.g., labeled with tag 7006). If the order is a router order, the technology provider server may obtain cross times and/or cross venues for the security from the engine, and may initialize the order using the next scheduled time when the order should be sent and/or the next scheduled venue. The technology provider server may send the order to the order router.

The order router may validate that a route to the specified venue is available, and may place the order with an appropriate broker dealer, from broker dealers 1-N_{b} 520. The broker dealer may utilize its own execution algorithms 530 and/or order router 540 to send the order, at the next scheduled time, to the next scheduled venue for execution.

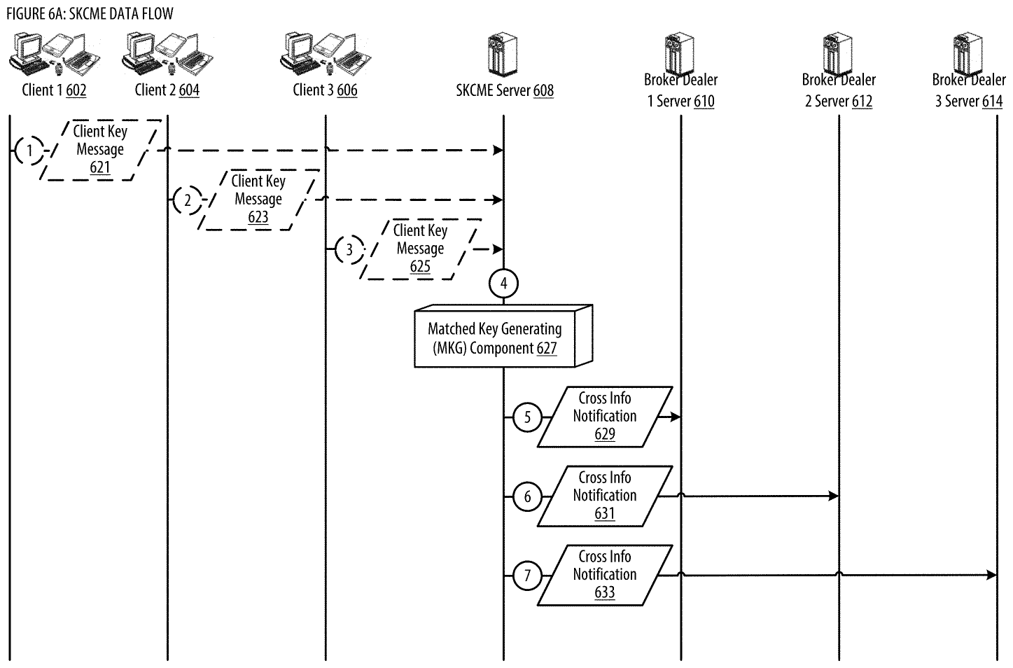

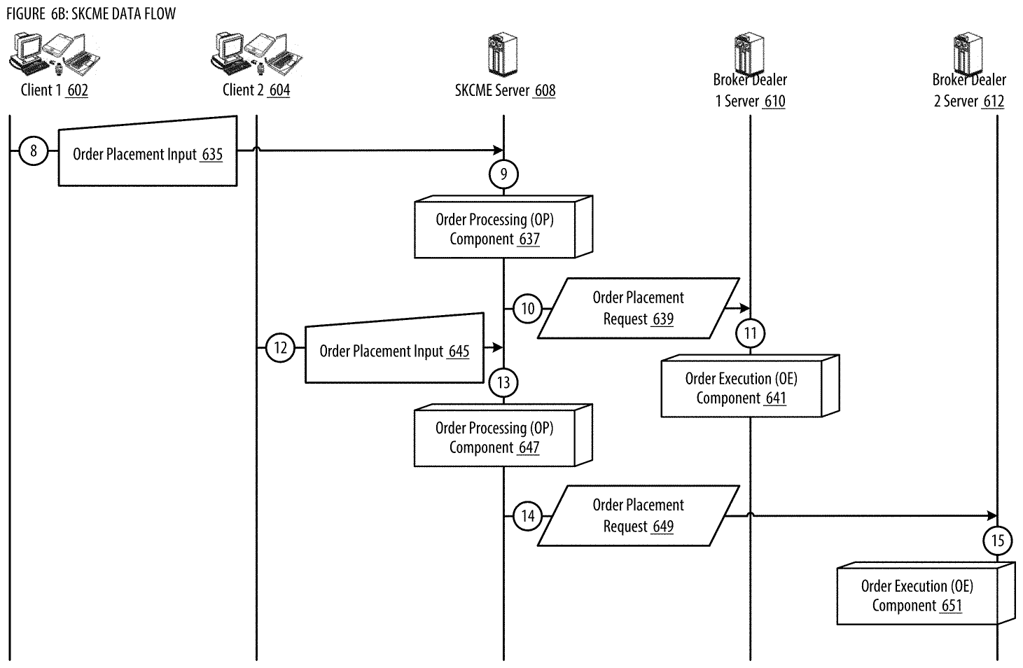

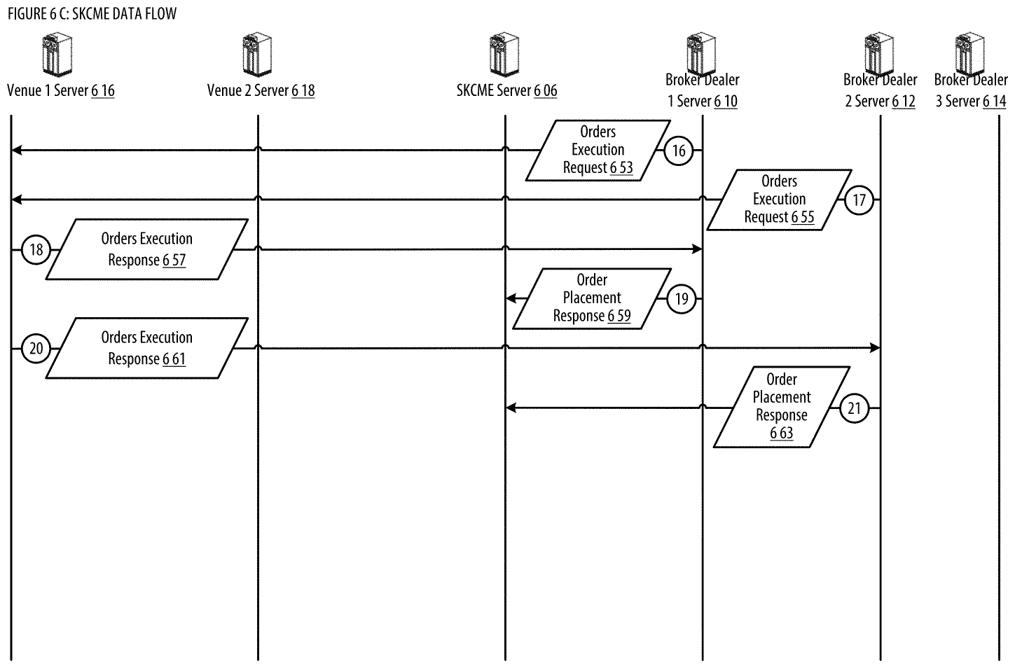

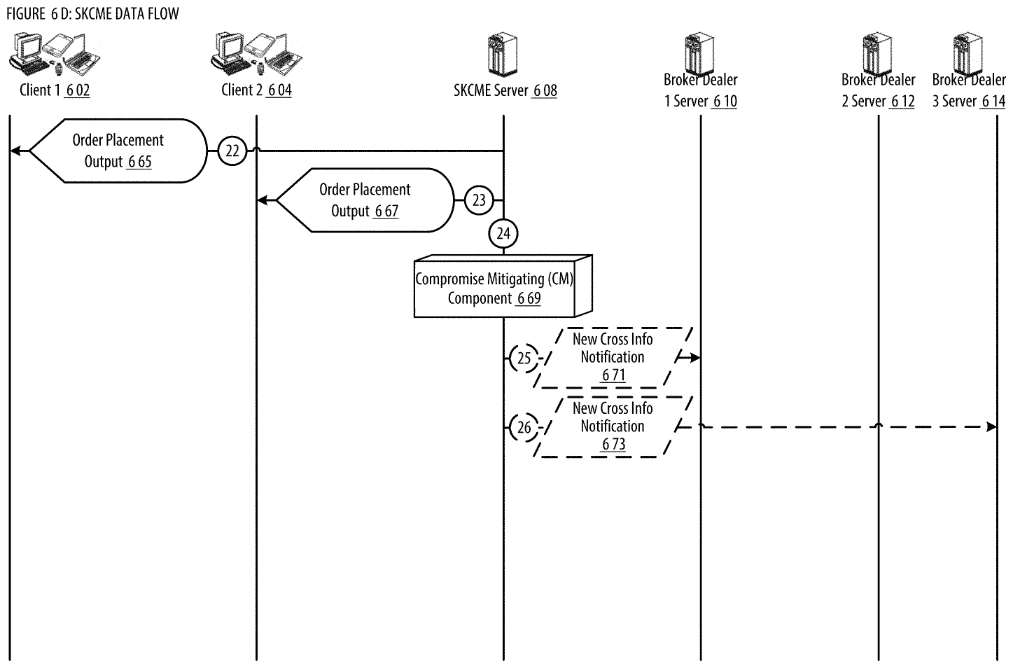

FIGS. 6A-D show a datagraph illustrating data flow(s) for the SKCME. In FIGS. 6A-D, dashed lines indicate data flow elements that may be more likely to be optional. In FIGS. 6A-D, client 1 602, client 2 604, and client 3 606 of counterparties may send a client key message 621, a client key message 623, and a client key message 625, respectively, to a SKCME server 608 to facilitate generating matched keys based on client keys. In one implementation, a client key message may include data such as a request identifier, a client (e.g., counterparty) identifier, a client key, and/or the like. In one embodiment, a client may provide the following example client key message, substantially in the form of a HTTP(S) POST message including XML-formatted data, as provided below:

POST /client_key_message.php HTTP/1.1
Host: www.server.com
Content-Type: Application/XML
Content-Length: 667
<?XML version = “1.0” encoding = “UTF-8”?>
<client_key_message>

<request_identifier>ID_request_11</request_identifier>
<client_identifier>ID_client_1</client_identifier>
<client_key>secret cryptographic key generated by client
1</client_key>

</client_key_message>

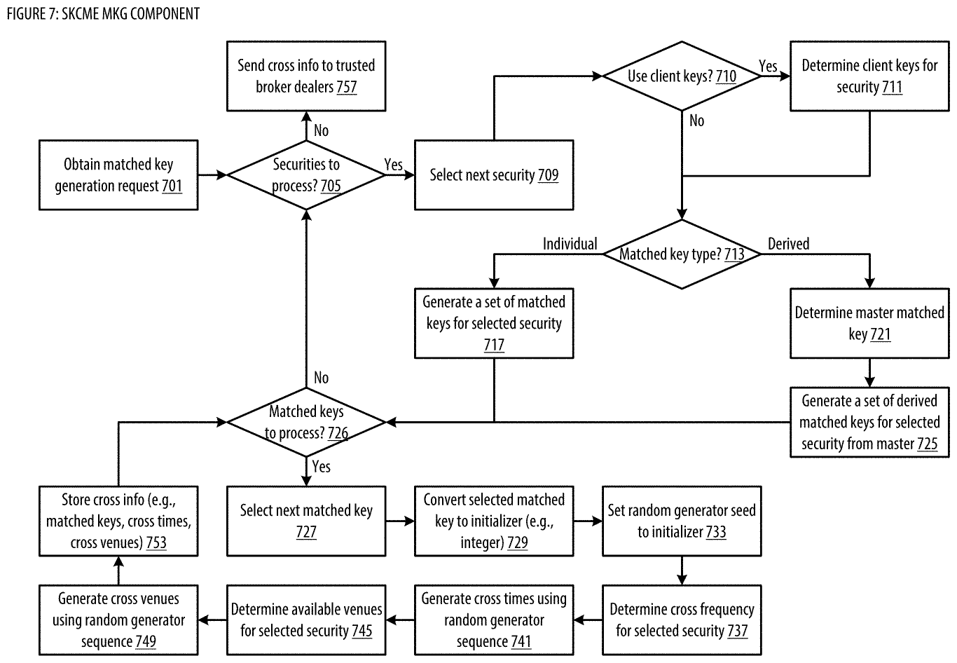

A matched key generating (MKG) component 627 may generate (e.g., generate dynamically at order arrival, precompute before market opens) cross info (e.g., sets of matched keys, cross times, cross venues, and/or the like) to facilitate matching the counterparties. See FIG. 7 for additional details regarding the MKG component.

The SKCME server 608 may send a cross info notification 629, a cross info notification 631, and a cross info notification 633 to broker dealer 1 server 610, broker dealer 2 server 612, and broker dealer 3 server 614, respectively, to provide cross info to trusted broker dealers. In one implementation (e.g., when the broker dealers generate cross times and cross venues based on matched keys), a cross info notification may include data such as a request identifier, security identifiers, matched keys, and/or the like. In one embodiment, the SKCME server may provide the following example cross info notification, substantially in the form of a HTTP(S) POST message including XML-formatted data, as provided below:

POST /cross_info_notification.php HTTP/1.1
Host: www.server.com
Content-Type: Application/XML
Content-Length: 667
<?XML version = “1.0” encoding = “UTF-8”?>
<cross_info_notification>

<request_identifier>ID_request_12</request_identifier>
<cross_info>

<security_identifier>AAPL</security_identifier>
<matched_key>1263182720</matched_key>

</cross_info>
<cross_info>

<security_identifier>IBM</security_identifier>
<matched_key>1464810592</matched_key>

</cross_info>
<cross_info>

<security_identifier>FB</security_identifier>
<matched_key>493988352</matched_key>

</cross_info>
...

</cross_info_notification>

In another implementation (e.g., when the SKCME server provides the broker dealers with cross times and cross venues), a cross info notification may include data such as a request identifier, security identifiers, cross times, cross venues, and/or the like. In one embodiment, the SKCME server may provide the following example cross info notification, substantially in the form of a HTTP(S) POST message including XML-formatted data, as provided below:

POST /cross_info_notification.php HTTP/1.1
Host: www.server.com
Content-Type: Application/XML
Content-Length: 667
<?XML version = “1.0” encoding = “UTF-8”?>
<cross_info_notification>

<request_identifier>ID_request_12</request_identifier>
<cross_info>

<security_identifier>AAPL</security_identifier>
<cross_times>

09:30:51.941 09:31:14.173 09:32:10.836 09:33:29.935
09:34:06.429 ...

</cross_times>
<cross_venues>

9 5 7 5 3 9 7 1 1 0 4 0 1 6 8 5 7 6 6 9 4 9 4 4 7 8 4 6 3 2 0
3 6 2 7 9 2 ...

</cross_venues>

</cross_info>
...

</cross_info_notification>

Client 1 602 (e.g., of a first counterparty) may send an order placement input 635 to the SKCME server 608 to facilitate placing an order (e.g., a buy order) for a security. For example, client 1 may be a desktop, a laptop, a tablet, a smartphone, a smartwatch, and/or the like that is executing a client application. In one implementation, the order placement input may include data such as a request identifier, an order type, a security identifier, a quantity, an execution algorithm identifier, and/or the like. In one embodiment, client 1 may provide the following example order placement input, substantially in the form of a HTTP(S) POST message including XML-formatted data, as provided below:

POST /authrequest.php HTTP/1.1
Host: www.server.com
Content-Type: Application/XML
Content-Length: 667
<?XML version = “1.0” encoding = “UTF-8”?>
<auth_request>

<timestamp>2020-12-31 09:30:01</timestamp>
<user_accounts_details>

<user_account_credentials>

<user_name>JohnDaDoeDoeDoooe@gmail.com</user_name>
<password>abc123</password>
//OPTIONAL <cookie>cookieID</cookie>
//OPTIONAL <digital_cert_link>www.mydigitalcertificate.com/

JohnDoeDaDoeDoe@gmail.com/mycertifcate.dc</digital_cert_link>

//OPTIONAL <digital_certificate>_DATA_</digital_certificate>

</user_account_credentials>

</user_accounts_details>
<client_details> //iOS Client with App and Webkit

//it should be noted that although several client details
//sections are provided to show example variants of client
//sources, further messages will include only on to save
//space

<client_IP>10.0.0.123</client_IP>
<user_agent_string>Mozilla/5.0 (iPhone; CPU iPhone OS 7_1_1 like Mac OS X)

AppleWebKit/537.51.2 (KHTML, like Gecko) Version/7.0 Mobile/11D201
Safari/9537.53</user_agent_string>

<client_product_type>iPhone6,1</client_product_type>
<client_serial_number>DNXXX1X1XXXX</client_serial_number>
<client_UDID>3XXXXXXXXXXXXXXXXXXXXXXXXD</client_UDID>
<client_OS>iOS</client_OS>
<client_OS_version>7.1.1</client_OS_version>
<client_app_type>app with webkit</client_app_type>
<app_installed_flag>true</app_installed_flag>
<app_name>SKCME.app</app_name>
<app_version>1.0 </app_version>
<app_webkit_name>Mobile Safari</client_webkit_name>
<client_version>537.51.2</client_version>

</client_details>
<client_details> //iOS Client with Webbrowser

<client_IP>10.0.0.123</client_IP>
<user_agent_string>Mozilla/5.0 (iPhone; CPU iPhone OS 7_1_1 like Mac OS X)

AppleWebKit/537.51.2 (KHTML, like Gecko) Version/7.0 Mobile/11D201
Safari/9537.53</user_agent_string>

<client_product_type>iPhone6,1</client_product_type>
<client_serial_number>DNXXX1X1XXXX</client_serial_number>
<client_UDID>3XXXXXXXXXXXXXXXXXXXXXXXXD</client_UDID>
<client_OS>iOS</client_OS>
<client_OS_version>7.1.1</client_OS_version>
<client_app_type>web browser</client_app_type>
<client_name>Mobile Safari</client_name>
<client_version>9537.53</client_version>

</client_details>
<client_details> //Android Client with Webbrowser

<client_IP>10.0.0.123</client_IP>
<user_agent_string>Mozilla/5.0 (Linux; U; Android 4.0.4; en-us; Nexus S

Build/IMM76D) AppleWebKit/534.30 (KHTML, like Gecko) Version/4.0 Mobile
Safari/534.30</user_agent_string>

<client_product_type>Nexus S</client_product_type>
<client_serial_number>YXXXXXXXXZ</client_serial_number>
<client_UDID>FXXXXXXXXX-XXXX-XXXX-XXXX-XXXXXXXXXXXXX</client_UDID>
<client_OS>Android</client_OS>
<client_OS_version>4.0.4</client_OS_version>
<client_app_type>web browser</client_app_type>
<client_name>Mobile Safari</client_name>
<client_version>534.30</client_version>

</client_details>
<client_details> //Mac Desktop with Webbrowser

<client_IP>10.0.0.123</client_IP>
<user_agent_string>Mozilla/5.0 (Macintosh; Intel Mac OS X 10_9_3)

AppleWebKit/537.75.14 (KHTML, like Gecko) Version/7.0.3
Safari/537.75.14</user_agent_string>

<client_product_type>MacPro5,1</client_product_type>
<client_serial_number>YXXXXXXXXZ</client_serial_number>
<client_UDID>FXXXXXXXXX-XXXX-XXXX-XXXX-XXXXXXXXXXXXX</client_UDID>
<client_OS>Mac OS X</client_OS>
<client_OS_version>10.9.3</client_OS_version>
<client_app_type>web browser</client_app_type>
<client_name>Mobile Safari</client_name>
<client_version>537.75.14</client_version>

</client_details>
<order_placement_input>

<request_identifier>ID_request_13</request_identifier>
<order_type>BUY</order_type>
<security_identifier>AAPL</security_identifier>
<order_quantity>100,000</order_quantity>
<execution_algorithm_identifier>ID_alg_1</execution_algorithm_identifier>

</order_placement_input>

</auth_request>

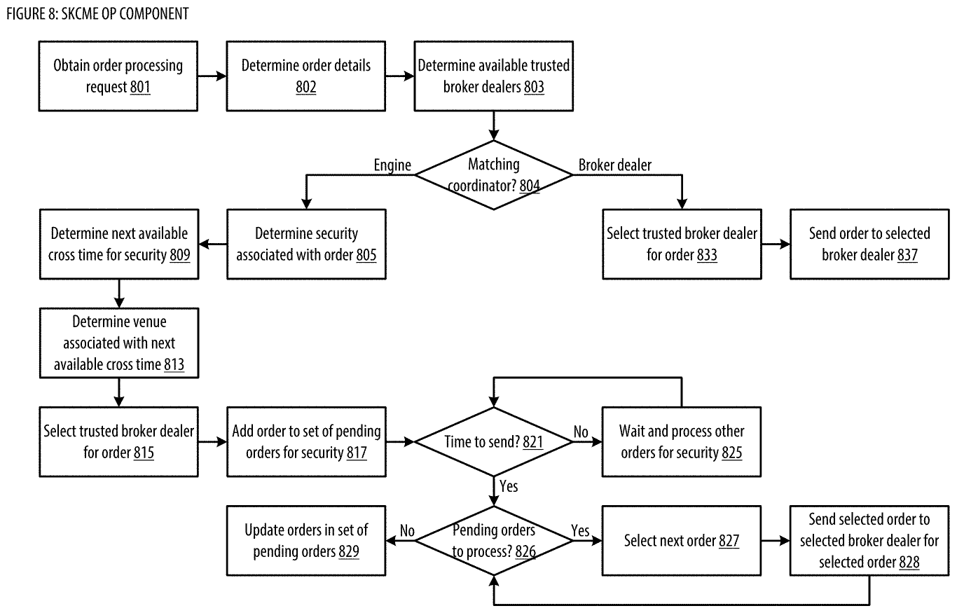

An order processing (OP) component 637 may utilize data provided in order placement inputs to facilitate sending pending orders for a scheduled cross time for a scheduled cross venue to one or more trusted broker dealers. See FIG. 8 for additional details regarding the OP component.

The SKCME server 608 may send an order placement request 639 to broker dealer 1 server 610 to facilitate sending pending orders. In one implementation, the order placement request may include data such as a request identifier, an order identifier, an order type, a security identifier, a quantity, an execution algorithm identifier, a cross time, a cross venue, and/or the like. In one embodiment, the SKCME server may provide the following example order placement request, substantially in the form of a HTTP(S) POST message including XML-formatted data, as provided below:

POST /order_placement_request.php HTTP/1.1
Host: www.server.com
Content-Type: Application/XML
Content-Length: 667
<?XML version = “1.0” encoding = “UTF-8”?>
<order_placement_request>

<request_identifier>ID_request_14</request_identifier>
<order_identifier>ID_order_1</order_identifier>
<order_type>BUY</order_type>
<security_identifier>AAPL</security_identifier>
<order_quantity>100,000</order_quantity>

</order_placement_request>

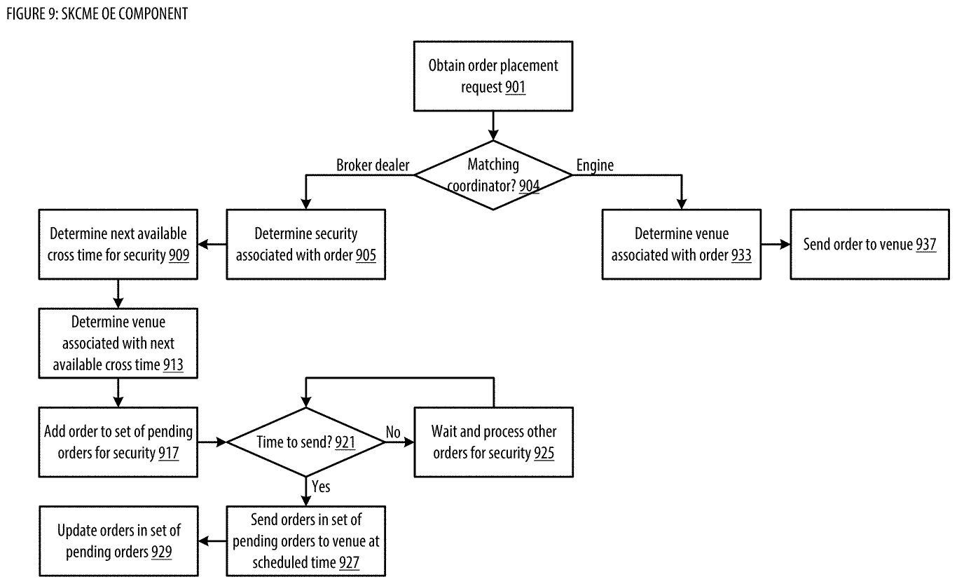

An order execution (OE) component 641 may utilize data provided in the order placement request 639 to facilitate sending pending orders at a scheduled cross time to a scheduled cross venue (e.g., venue 1 server 616, venue 2 server 618). See FIG. 9 for additional details regarding the OE component.

Client 2 604 (e.g., of a second counterparty) may send an order placement input 645 to the SKCME server 608 to facilitate placing an order (e.g., a sell order) for the security. For example, client 2 may be a desktop, a laptop, a tablet, a smartphone, a smartwatch, and/or the like that is executing a client application. In one implementation, the order placement input may include data such as a request identifier, an order type, a security identifier, a quantity, an execution algorithm identifier, and/or the like. In one embodiment, client 2 may provide the following example order placement input, substantially in the form of a HTTP(S) POST message including XML-formatted data, as provided below:

POST /authrequest.php HTTP/1.1
Host: www.server.com
Content-Type: Application/XML
Content-Length: 667
<?XML version = “1.0” encoding = “UTF-8”?>
<auth_request>

<timestamp>2020-12-31 09:30:02</timestamp>
<user_accounts_details>

<user_account_credentials>

<user_name>BobDaDoeDoeDoooe@gmail.com</user_name>
<password>def456</password>
//OPTIONAL <cookie>cookieID</cookie>
//OPTIONAL <digital_cert_link>www.mydigitalcertificate.com/

BobDoeDaDoeDoe@gmail.com/mycertifcate.dc</digital_cert_link>

//OPTIONAL <digital_certificate>_DATA_</digital_certificate>

</user_account_credentials>

</user_accounts_details>
<client_details> //iOS Client with App and Webkit

//it should be noted that although several client details
//sections are provided to show example variants of client
//sources, further messages will include only on to save
//space

<client_IP>10.0.0.124</client_IP>
<user_agent_string>Mozilla/5.0 (iPhone; CPU iPhone OS 7_1_1 like Mac OS X)

AppleWebKit/537.51.2 (KHTML, like Gecko) Version/7.0 Mobile/11D201
Safari/9537.53</user_agent_string>

<client_product_type>iPhone6,1</client_product_type>
<client_serial_number>DNXXX1X1XXXX</client_serial_number>
<client_UDID>3XXXXXXXXXXXXXXXXXXXXXXXXD</client_UDID>
<client_OS>iOS</client_OS>
<client_OS_version>7.1.1</client_OS_version>
<client_app_type>app with webkit</client_app_type>
<app_installed_flag>true</app_installed_flag>
<app_name>SKCME.app</app_name>
<app_version>1.0 </app_version>
<app_webkit_name>Mobile Safari</client_webkit_name>
<client_version>537.51.2</client_version>

</client_details>
<client_details> //iOS Client with Webbrowser

<client_IP>10.0.0.124</client_IP>
<user_agent_string>Mozilla/5.0 (iPhone; CPU iPhone OS 7_1_1 like Mac OS X)

AppleWebKit/537.51.2 (KHTML, like Gecko) Version/7.0 Mobile/11D201
Safari/9537.53</user_agent_string>

<client_product_type>iPhone6,1</client_product_type>
<client_serial_number>DNXXX1X1XXXX</client_serial_number>
<client_UDID>3XXXXXXXXXXXXXXXXXXXXXXXXD</client_UDID>
<client_OS>iOS</client_OS>
<client_OS_version>7.1.1</client_OS_version>
<client_app_type>web browser</client_app_type>
<client_name>Mobile Safari</client_name>
<client_version>9537.53</client_version>

</client_details>
<client_details> //Android Client with Webbrowser

<client_IP>10.0.0.124</client_IP>
<user_agent_string>Mozilla/5.0 (Linux; U; Android 4.0.4; en-us; Nexus S

Build/IMM76D) AppleWebKit/534.30 (KHTML, like Gecko) Version/4.0 Mobile
Safari/534.30</user_agent_string>

<client_product_type>Nexus S</client_product_type>
<client_serial_number>YXXXXXXXXZ</client_serial_number>
<client_UDID>FXXXXXXXXX-XXXX-XXXX-XXXX-XXXXXXXXXXXXX</client_UDID>
<client_OS>Android</client_OS>
<client_OS_version>4.0.4</client_OS_version>
<client_app_type>web browser</client_app_type>
<client_name>Mobile Safari</client_name>
<client_version>534.30</client_version>

</client_details>
<client_details> //Mac Desktop with Webbrowser

<client_IP>10.0.0.124</client_IP>
<user_agent_string>Mozilla/5.0 (Macintosh; Intel Mac OS X 10_9_3)

AppleWebKit/537.75.14 (KHTML, like Gecko) Version/7.0.3
Safari/537.75.14</user_agent_string>

<client_product_type>MacPro5,1</client_product_type>
<client_serial_number>YXXXXXXXXZ</client_serial_number>
<client_UDID>FXXXXXXXXX-XXXX-XXXX-XXXX-XXXXXXXXXXXXX</client_UDID>
<client_OS>Mac OS X</client_OS>
<client_OS_version>10.9.3</client_OS_version>
<client_app_type>web browser</client_app_type>
<client_name>Mobile Safari</client_name>
<client_version>537.75.14</client_version>

</client_details>
<order_placement_input>

<request_identifier>ID_request_15</request_identifier>
<order_type>SELL</order_type>
<security_identifier>AAPL</security_identifier>
<order_quantity>200,000</order_quantity>
<execution_algorithm_identifier>ID_alg_2</execution_algorithm_identifier>

</order_placement_input>

</auth_request>

An order processing (OP) component 647 may utilize data provided in order placement inputs to facilitate sending pending orders for a scheduled cross time for a scheduled cross venue to one or more trusted broker dealers. See FIG. 8 for additional details regarding the OP component.

The SKCME server 608 may send an order placement request 649 to broker dealer 2 server 612 to facilitate sending pending orders. In one implementation, the order placement request may include data such as a request identifier, an order identifier, an order type, a security identifier, a quantity, an execution algorithm identifier, a cross time, a cross venue, and/or the like. In one embodiment, the SKCME server may provide the following example order placement request, substantially in the form of a HTTP(S) POST message including XML-formatted data, as provided below:

POST /order_placement_request.php HTTP/1.1
Host: www.server.com
Content-Type: Application/XML
Content-Length: 667
<?XML version = “1.0” encoding = “UTF-8”?>
<order_placement_request>

<request_identifier>ID_request_16</request_identifier>
<order_identifier>ID_order_2</order_identifier>
<order_type>SELL</order_type>
<security_identifier>AAPL</security_identifier>
<order_quantity>200,000</order_quantity>
<cross_time>09:30:51.941</cross_time>
<cross_venue>ID_venue_1</cross_venue>

</order_placement_request>

An order execution (OE) component 651 may utilize data provided in the order placement request 649 to facilitate sending pending orders at a scheduled cross time to a scheduled cross venue (e.g., venue 1 server 616, venue 2 server 618). See FIG. 9 for additional details regarding the OE component.

Broker dealer 1 server 610 may send an orders execution request 653 to venue 1 server 616 to facilitate execution of its pending orders. In one implementation, the orders execution request may include data such as a request identifier, orders data, and/or the like. In one embodiment, broker dealer 1 server may provide the following example orders execution request, substantially in the form of a HTTP(S) POST message including XML-formatted data, as provided below:

POST /orders_execution_request.php HTTP/1.1
Host: www.server.com
Content-Type: Application/XML
Content-Length: 667
<?XML version = “1.0” encoding = “UTF-8”?>
<orders_execution_request>

<request_identifier>ID_request_17</request_identifier>
<orders>

<order>

<order_identifier>ID_order_1</order_identifier>
<order_type>BUY</order_type>
<security_identifier>AAPL</security_identifier>
<order_quantity>100,000</order_quantity>

</order>
...

</orders>

</orders_execution_request>

Broker dealer 2 server 612 may send an orders execution request 655 to venue 1 server 616 to facilitate execution of its pending orders. In one implementation, the orders execution request may include data such as a request identifier, orders data, and/or the like. In one embodiment, broker dealer 2 server may provide the following example orders execution request, substantially in the form of a HTTP(S) POST message including XML-formatted data, as provided below:

POST /orders_execution_request.php HTTP/1.1
Host: www.server.com
Content-Type: Application/XML
Content-Length: 667
<?XML version = “1.0” encoding = “UTF-8”?>
<orders_execution_request>

<request_identifier>ID_request_18</request_identifier>
<orders>

<order>

<order_identifier>ID_order_2</order_identifier>
<order_type>SELL</order_type>
<security_identifier>AAPL</security_identifier>
<order_quantity>200,000</order_quantity>

</order>
...

</orders>

</orders_execution_request>

Venue 1 server 616 may send an orders execution response 657 to broker dealer 1 server 610 to inform broker dealer 1 server whether its orders were executed successfully. In one implementation, the orders execution response may include data such as a response identifier, orders status data, and/or the like. In one embodiment, venue 1 server may provide the following example orders execution response, substantially in the form of a HTTP(S) POST message including XML-formatted data, as provided below:
POST/orders_execution_response.php HTTP/1.1

Host: www.server.com
Content-Type: Application/XML
Content-Length: 667
<?XML version = “1.0” encoding = “UTF-8”?>
<orders_execution_response>

<response_identifier>ID_response_17</response_identifier>
<orders>

<order>

<order_identifier>ID_order_1</order_identifier>
<order_status>FILLED</order_status>

</order>
...

</orders>

</orders_execution_response>

Broker dealer 1 server 610 may send an order placement response 659 to the SKCME server 606 to inform the SKCME server whether its orders were executed successfully. In one implementation, the order placement response may include data such as a response identifier, orders status data, and/or the like. In one embodiment, broker dealer 1 server may provide the following example order placement response, substantially in the form of a HTTP(S) POST message including XML-formatted data, as provided below:

POST /order_placement_response.php HTTP/1.1
Host: www.server.com
Content-Type: Application/XML
Content-Length: 667
<?XML version = “1.0” encoding = “UTF-8”?>
<order_placement_response>

<response_identifier>ID_response_14</response_identifier>
<orders>

<order>

<order_identifier>ID_order_1</order_identifier>
<order_status>FILLED</order_status>

</order>
...

</orders>

</order_placement_response>

Venue 1 server 616 may send an orders execution response 661 to broker dealer 2 server 612 to inform broker dealer 2 server whether its orders were executed successfully. In one implementation, the orders execution response may include data such as a response identifier, orders status data, and/or the like. In one embodiment, venue 1 server may provide the following example orders execution response, substantially in the form of a HTTP(S) POST message including XML-formatted data, as provided below:

POST /orders_execution_response.php HTTP/1.1
Host: www.server.com
Content-Type: Application/XML
Content-Length: 667
<?XML version = “1.0” encoding = “UTF-8”?>
<orders_execution_response>

<response_identifier>ID_response_18</response_identifier>
<orders>

<order>

<order_identifier>ID_order_2</order_identifier>
<order_status>PARTIALLY_FILLED</order_status>
<quantity_filled>100,000</quantity_filled>

</order>
...

</orders>

</orders_execution_response>

Broker dealer 2 server 612 may send an order placement response 663 to the SKCME server 606 to inform the SKCME server whether its orders were executed successfully. In one implementation, the order placement response may include data such as a response identifier, orders status data, and/or the like. In one embodiment, broker dealer 2 server may provide the following example order placement response, substantially in the form of a HTTP(S) POST message including XML-formatted data, as provided below:

POST /order_placement_response.php HTTP/1.1
Host: www.server.com
Content-Type: Application/XML
Content-Length: 667
<?XML version = “1.0” encoding = “UTF-8”?>
<order_placement_response>

<response_identifier>ID_response_16</response_identifier>
<orders>

<order>

<order_identifier>ID_order_2</order_identifier>
<order_status>PARTIALLY_FILLED</order_status>
<quantity_filled>100,000</quantity_filled>

</order>
...

</orders>

</order_placement_response>

The SKCME server 608 may send an order placement output 665 to client 1 602 to inform the first counterparty regarding the status of the first counterparty's order. In one implementation, the order placement output may include data such as a response identifier, a status, and/or the like. In one embodiment, the SKCME server may provide the following example order placement output, substantially in the form of a HTTP(S) POST message including XML-formatted data, as provided below:

POST /order_placement_output.php HTTP/1.1
Host: www.server.com
Content-Type: Application/XML
Content-Length: 667
<?XML version = “1.0” encoding = “UTF-8”?>
<order_placement_output>

<response_identifier>ID_response_13</response_identifier>
<order_status>FILLED</order_status>

</order_placement_output>

The SKCME server 608 may send an order placement output 667 to client 2 604 to inform the second counterparty regarding the status of the second counterparty's order. In one implementation, the order placement output may include data such as a response identifier, a status, and/or the like. In one embodiment, the SKCME server may provide the following example order placement output, substantially in the form of a HTTP(S) POST message including XML-formatted data, as provided below:

POST /order_placement_output.php HTTP/1.1
Host: www.server.com
Content-Type: Application/XML
Content-Length: 667
<?XML version = “1.0” encoding = “UTF-8”?>
<order_placement_output>

<response_identifier>ID_response_15</response_identifier>
<order_status>PARTIALLY_FILLED</order_status>
<quantity_filled>100,000</quantity_filled>

</order_placement_output>

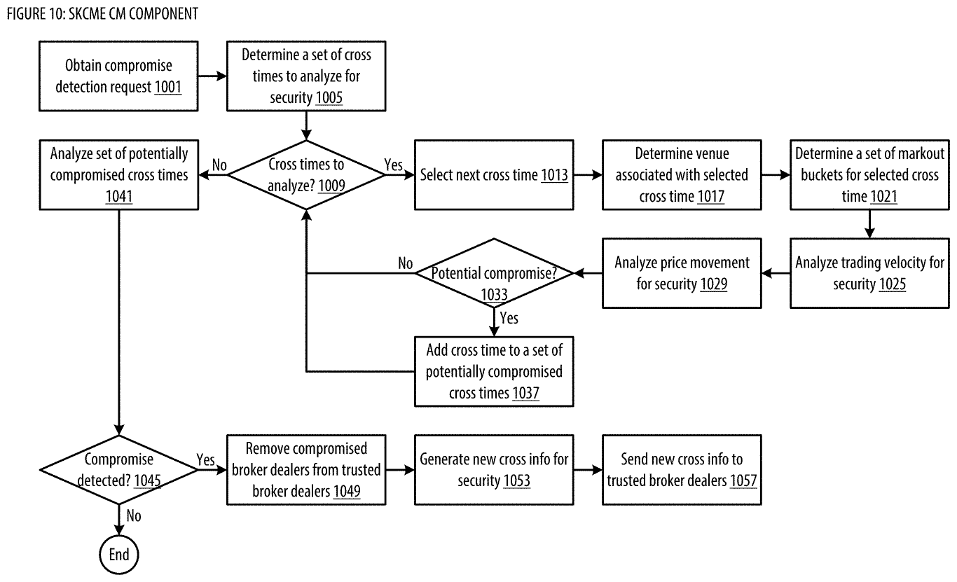

A compromise mitigating (CM) component 669 may analyze trading velocity, price movement, and/or the like around cross times to detect and/or mitigate potential security compromises (e.g., cross times and/or locations have been discovered by other counterparties). See FIG. 10 for additional details regarding the CM component.

If a compromise is detected, the SKCME server 608 may send a new cross info notification 671 and a new cross info notification 673 to broker dealer 1 server 610 and to broker dealer 3 server 614, respectively, to provide new generated cross info to trusted broker dealers (e.g., to broker dealer 1 server and broker dealer 3 server, but not to broker dealer 2 server). In one implementation (e.g., when the broker dealers generate cross times and cross venues based on matched keys), a new cross info notification may include data such as a request identifier, security identifiers, new matched keys, and/or the like. In another implementation (e.g., when the SKCME server provides the broker dealers with cross times and cross venues), a cross info notification may include data such as a request identifier, security identifiers, new cross times, new cross venues, and/or the like.

FIG. 7 shows a logic flow illustrating embodiments of a matched key generating (MKG) component for the SKCME. In FIG. 7, a matched key generation request may be obtained at 701. For example, the matched key generation request may be obtained as a result of running an overnight process to generate cross info (e.g., sets of matched keys, cross times, cross venues, and/or the like). In another example, the matched key generation request may be obtained as a result of an order arrival to dynamically generate cross info for securities associated with the order. It is to be understood that, in some embodiments, instead of generating different cross info for each security, global cross info may be generated for securities.

A determination may be made at 705 whether there remain securities to process. In one implementation, each of the securities (e.g., securities in the universe of covered securities, such as equities; securities associated with the order) may be processed. If there remain securities to process, the next security may be selected for processing at 709.

A determination may be made at 710 whether to use client keys to generate matched keys. In one implementation, a set of counterparties may each submit a client key, and the combination of the client keys may be used to generate a matched key for the selected security used to determine cross times and/or venues for use by the counterparties in the set. If client keys should be used, client keys for the selected security may be determined at 711. In one implementation, obtained client key messages may be parsed (e.g., using PHP commands) to determine the client keys (e.g., based on the value of the client_key field).

A determination may be made at 713 regarding the matched key type to utilize (e.g., based on a configuration setting). If individual matched keys should be utilized, a set of matched keys for the selected security may be generated at 717. In one embodiment, a single matched key may be generated. In another embodiment, multiple hierarchical matched keys may be generated, such that an execution algorithm may switch from using cross times and/or venues generated based on a current matched key (e.g., K_{M1}) to using cross times and/or venues generated based on a subsequent matched key (e.g., K_{M2}) when orders are successfully matched using the current matched key. For example, a matched key may be a secret key in the form of a data structure such as a string, a number, a custom data type, and/or the like. In one implementation, the set of matched keys may be created by generating private cryptographic keys (e.g., numbers, custom data types) associated with the selected security. In another implementation, the set of matched keys may be created by generating values (e.g., strings) associated with the selected security (e.g., phrases, such as “secret room”, “finding others”, “i don't want to know”; concatenations of the selected security's ticker and a random number; concatenations of the client keys for the selected security and a random number).

If derived matched keys should be utilized, a master matched key may be determined at 721. For example, instead of generating completely different matched keys for each security, a master matched key may be used (e.g., for a specified duration, such as a day) to generate derived matched keys for each security. In one implementation, the master matched key may be created by generating a private cryptographic key (e.g., a number, a custom data type). In another implementation, the master matched key may be a created by generating a value (e.g., a string, such as “Fibonacci Numbers”). In another implementation, the master matched key may be a concatenation of the client keys for the selected security. A set of derived matched keys for the selected security may be generated from the master matched key at 725. In one embodiment, a single derived matched key may be generated. In another embodiment, multiple derived hierarchical matched keys may be generated, such that an execution algorithm may switch from using cross times and/or venues generated based on a current derived matched key (e.g., K_{M1}) to using cross times and/or venues generated based on a subsequent derived matched key (e.g., K_{M2}) when orders are successfully matched using the current derived matched key. In one implementation, a set of derived matched keys may be generated using a concatenation method. For example, derived matched keys may be created as follows:
Master Key=“Fibonacci Numbers”
Derived Keys
AAPL K_{M1}=“Fibonacci Numbers AAPL 123”
AAPL K_{M2}=“Fibonacci Numbers AAPL 456”
AAPL K_{M3}=“Fibonacci Numbers AAPL 789”
IBM K_{M1}=“Fibonacci Numbers IBM 692”
IBM K_{M2}=“Fibonacci Numbers IBM 308”
IBM K_{M3}=“Fibonacci Numbers IBM 287”

In another implementation, a set of derived matched keys may be generated using a modulo sum method (e.g., using modulo 2147438648 of the sum). For example, derived matched keys may be created as follows:
Master Key=“Fibonacci Numbers”
Derived Keys
AAPL K_{M1}=“Fibonacci Numbers”+“AAPL”+“123”
AAPL K_{M2}=“Fibonacci Numbers”+“AAPL”+“456”
AAPL K_{M3}=“Fibonacci Numbers”+“AAPL”+“789”
IBM K_{M1}=“Fibonacci Numbers”+“IBM”+“692”
IBM K_{M2}=“Fibonacci Numbers”+“IBM”+“308”
IBM K_{M3}=“Fibonacci Numbers”+“IBM”+“287”

A determination may be made at 726 whether there remain matched keys in the set of generated matched keys for the selected security to process. In one implementation, each of the generated matched keys may be processed. If there remain matched keys to process, the next matched key may be selected for processing at 727.

The selected matched key may be converted to an initializer (e.g., integer initializer) at 729. In one implementation, a conversion calculation similar to the following may be utilized (e.g., using the Q query language for kdb+):
Conversion Calculation
{“int$x mod 2147483648} {sum x*16 xexp til count x} 15#first 16 vs md5 matched_key
Exemplary Results
“secret room”→670625152

A random generator seed of a random number generator may be set to the initializer at 733. For example, the random generator seed of the random number generator may be set to the initializer as follows:
Setseed[670625152]

A cross frequency for the selected security may be determined at 737. In one implementation, the cross frequency (e.g., the number of scheduled execution times that may be used for the selected security per day) may be specified in a configuration setting. For example, a cross frequency of 390 crosses per day may be utilized (e.g., one cross per minute during the 6.5 hours during which the markets are open). In another implementation, the cross frequency may be generated using a random number generator.

Cross times may be generated using a sequence from the random number generator at 741. In one implementation, a cross time (e.g., one cross time per minute) may be generated (e.g., with timestamp accuracy out to the millisecond) for each cross frequency period (e.g., one minute—the cross frequency period may be calculated, in minutes, as 390 divided by the cross frequency). For example, the cross times may be calculated as follows:
Exemplary Calculation
crosstime: 09:30:00.000+(60000*til 390)+390?60000
Exemplary Results
09:30:51.941 09:31:14.173 09:32:10.836 09:33:29.935 09:34:06.429 09:35:02.321 . . .

In another implementation, the cross times may be generated using exponential distribution between time. For example, the cross times may be calculated as follows:
Exemplary Calculation
crosstime: 09:30:00.000+‘int$sums neg 60000*(log 390?1f)
Exemplary Results
09:30:01.795 09:30:50.432 09:32:19.033 09:34:06.054 09:34:52.926 09:35:29.389 . . .

Available venues for the selected security may be determined at 745. For example, the available venues may be stock exchanges, dark pools, and/or the like where the selected security may be traded. In one implementation, a database may be queried to determine the number of available venues for the selected security. For example, the number of available venues (e.g., 10 venues) for the selected security may be determined via a MySQL database command similar to the following:

SELECT COUNT(venue)
FROM market_data
WHERE asset_ID = “AAPL”;

Cross venues may be generated using a sequence from the random number generator at 749. In one implementation, a cross venue (e.g., 0=NYSE, 1=NASDAQ, 2=a dark pool, etc.) may be generated for each cross time (e.g., one cross venue per minute). For example, the cross venues may be calculated as follows:
Exemplary Calculation
crossvenue: 390?10//assume there are 10 available venues
Exemplary Results
9 5 7 5 3 9 7 1 1 0 4 0 1 6 8 5 7 6 6 9 4 9 4 4 7 8 4 6 3 2 0 3 6 2 7 9 2 1 9 . . .

Cross info (e.g., matched keys, cross times, cross venues) may be stored at 753. In one implementation, the cross info for the selected matched key may be stored in a database (e.g., in cross_info table 1919j). For example, the cross info may be stored via a MySQL database command similar to the following:
INSERT INTO cross_info (asset_ID, assetMatchedKey, assetCrossTimes, assetCrossVenues)
VALUES (“AAPL”, vaLue of AAPL K_{M1}, cross times for AAPL K_{M1}, cross venues for AAPL K_{M1});

The cross info may be sent to trusted broker dealers at 757. For example, the cross info may be sent via one or more cross info notifications, new cross info notifications, and/or the like.

FIG. 8 shows a logic flow illustrating embodiments of an order processing (OP) component for the SKCME. In FIG. 8, an order processing request may be obtained at 801. For example, the order processing request may be obtained as a result of an order arrival from a client (e.g., via an order placement input) to facilitate execution of the order.

Order details of the order may be determined at 802. For example, the order details may include data such as a security identifier, order quantity, order type (e.g., peg mid; limit), order time, and/or the like. In one implementation, the order processing request may be parsed (e.g., using PHP commands) to determine the order details. It is to be understood that, in some embodiments, a plurality of securities and/or instructions (e.g., buy securities; sell securities) may be associated with the order and processed by the OP component.

Available trusted broker dealers may be determined at 803. For example, different trusted broker dealers may be available for different securities, order quantities, order types, order times, and/or the like. In one implementation, a database may be queried to determine the available trusted broker dealers. For example, the available trusted broker dealers may be determined via a MySQL database command similar to the following:

SELECT trustedBrokerDealers
FROM cross_info
WHERE asset_ID = “AAPL”;

A determination may be made at 804 regarding which entity is a matching coordinator. In one embodiment, the SKCME may be configured such that the engine is the matching coordinator. If the engine is the matching coordinator, a security associated with the order may be determined at 805. In one implementation, the order processing request may be parsed (e.g., using PHP commands) to determine the security identifier of the security (e.g., based on the value of the security_identifier field). In another implementation, the security identifier of the security may already be determined from 802.

The next available cross time for the security may be determined at 809. For example, the next available cross time may indicate when the order for the security should be sent for execution. In one implementation, the next available cross time may be determined by querying a database to determine cross times for the security and selecting the appropriate cross time based on the current time. For example, cross times for the security may be determined via a MySQL database command similar to the following:

SELECT assetCrossTimes
FROM cross_info
WHERE asset_ID = “AAPL”;

A venue associated with the next available cross time may be determined at 813. For example, the venue may indicate where (e.g., a stock exchange, a dark pool) the order for the security should be sent for execution. In one implementation, the venue may be determined by querying a database to determine venues for the security and selecting the venue corresponding to the next available cross time (e.g., based on sequence position, such as the 5^{th} venue for the 5^{th} cross time). For example, venues for the security may be determined via a MySQL database command similar to the following:

SELECT assetCrossVenues
FROM cross_info
WHERE asset_ID = “AAPL”;

A trusted broker dealer for the order may be selected at 815. In one implementation, the trusted broker dealer may be selected based on service cost (e.g., to minimize execution cost for the order given the order details, the venue, and/or the like). In another implementation, the trusted broker dealer may be selected from the available trusted broker dealers randomly.

The order may be added to a set of pending orders for the security at 817. For example, the set of pending orders for the security may include various orders (e.g., buy orders; sell orders) from various counterparties (e.g., approved to use the SKCME) that should be sent for execution at the next available cross time. In one implementation, the set of pending orders may be implemented as a linked list, array, etc. of order data structures (e.g., having data fields corresponding to data in the order field of an orders execution request and a data field that indicates the selected trusted broker dealer for the order).

A determination may be made at 821 whether it is time to send the orders in the set of pending orders for the security. In one implementation, the orders may be sent at the next available cross time. In another implementation, the orders may be sent some specified time (e.g., configured per broker dealer) before the next available cross time to account for latency associated with transmitting the orders for execution through a broker dealer.

If it is not yet time to send the orders to broker dealers, the OP component may wait and process other orders for the security at 825. For example, the OP component may process order placement input 635 from client 1 602 and order placement input 645 from client 2 604 before sending these two orders to broker dealer 1 server 610 and broker dealer 2 server 612, respectively.

If it is time to send the orders to broker dealers, a determination may be made at 826 whether there remain orders in the set of pending orders to process. In one implementation, each of the orders in the set of pending orders may be processed. If there remain pending orders to process, the next order may be selected for processing at 827.

The selected order may be sent to the selected broker dealer for the selected order at 828. For example, the selected order may be sent via an order placement request. In one embodiment, an order placement request specifying a plurality of orders may be sent. In another embodiment, a separate order placement request may be sent for each order. It is to be understood that a broker dealer may be sent buy orders, sell orders, or a combination of buy orders and sell orders.

The orders in the set of pending orders may be updated at 829. In one implementation, if an order was filled, the order datastructure corresponding to the order may be removed from the set of pending orders. In another implementation, if an order was partially filled, the order datastructure corresponding to the order may be updated so that the order_quantity field reflects the remaining quantity to be filled.

In another embodiment, the SKCME may be configured such that broker dealers are matching coordinators. If broker dealers are matching coordinators, a trusted broker dealer for the order may be selected at 833. In one implementation, the trusted broker dealer may be selected based on service cost (e.g., to minimize execution cost for the order given the order details). In another implementation, the trusted broker dealer may be selected from the available trusted broker dealers randomly.

The order may be sent to the selected broker dealer at 837. For example, the order may be sent via an order placement request.

FIG. 9 shows a logic flow illustrating embodiments of an order execution (OE) component for the SKCME. In FIG. 9, an order placement request may be obtained by a broker dealer server at 901. For example, the order placement request may be obtained as a result of a request from the SKCME server to facilitate execution of an order.

A determination may be made at 904 regarding which entity is a matching coordinator. In one embodiment, the SKCME may be configured such that the broker dealer server is the matching coordinator. If the broker dealer server is the matching coordinator, a security associated with the order may be determined at 905. In one implementation, the order placement request may be parsed (e.g., using PHP commands) to determine the security identifier of the security (e.g., based on the value of the security_identifier field). It is to be understood that, in some embodiments, a plurality of orders may be associated with the order placement request and processed by the OE component.

The next available cross time for the security may be determined at 909. For example, the next available cross time may indicate when the order for the security should be sent for execution. In one implementation, the next available cross time may be determined by querying a database to determine cross times for the security and selecting the appropriate cross time based on the current time. For example, cross times for the security may be determined via a MySQL database command similar to the following:

SELECT assetCrossTimes
FROM cross_info
WHERE asset_ID = “AAPL”;

A venue associated with the next available cross time may be determined at 913. For example, the venue may indicate where (e.g., a stock exchange, a dark pool) the order for the security should be sent for execution. In one implementation, the venue may be determined by querying a database to determine venues for the security and selecting the venue corresponding to the next available cross time (e.g., based on sequence position, such as the 5^{th} venue for the 5^{th} cross time). For example, venues for the security may be determined via a MySQL database command similar to the following:

SELECT assetCrossVenues
FROM cross_info
WHERE asset_ID = “AAPL”;

The order may be added to a set of pending orders for the security at 917. For example, the set of pending orders for the security may include various orders (e.g., buy orders; sell orders) from various counterparties (e.g., approved to use the SKCME) that should be sent for execution at the next available cross time. In one implementation, the set of pending orders may be implemented as a linked list, array, etc. of order data structures (e.g., having data fields corresponding to data in the order field of an orders execution request).

A determination may be made at 921 whether it is time to send the orders in the set of pending orders for the security. In one implementation, the orders may be sent at the next available cross time. In another implementation, the orders may be sent some specified time (e.g., configured per venue) before the next available cross time to account for latency associated with transmitting the orders for execution.

If it is not yet time to send the orders for execution, the OE component may wait and process other orders for the security at 925.

If it is time to send the orders for execution, the orders in the set of pending orders may be sent to the venue at the scheduled time at 927. For example, the orders may be sent via one or more orders execution requests. In one embodiment, an orders execution request specifying a plurality of orders may be sent. In another embodiment, a separate orders execution request may be sent for each order. In one implementation, an order may be sent as a short-term (e.g., typically less than 1 second) peg mid or limit order.

The orders in the set of pending orders may be updated at 929. In one implementation, if an order was filled, the order datastructure corresponding to the order may be removed from the set of pending orders. In another implementation, if an order was partially filled, the order datastructure corresponding to the order may be updated so that the order_quantity field reflects the remaining quantity to be filled.

In another embodiment, the SKCME may be configured such that the engine is the matching coordinator. If the engine is the matching coordinator, a venue associated with the next available cross time may be determined at 933. In one implementation, the order placement request may be parsed (e.g., using PHP commands) to determine the venue (e.g., based on the value of the cross_venue field).

The order may be sent to the venue at 937. For example, the order may be sent via an orders execution request. In one implementation, the order may be sent as a short-term (e.g., typically less than 1 second) peg mid or limit order.

FIG. 10 shows a logic flow illustrating embodiments of a compromise mitigating (CM) component for the SKCME. In FIG. 10, a compromise detection request may be obtained at 1001. For example, the compromise detection request may be obtained as a result of a periodically scheduled analysis (e.g., every 15 minutes) to detect whether information regarding cross times and/or cross venues for a security has been compromised (e.g., discovered by other unauthorized counterparties).

A set of cross times to analyze for the security may be determined at 1005. In one implementation, cross times since the last scheduled analysis may be determined (e.g., the last 15 cross times, assuming 1 cross time per minute) by querying a database to determine cross times for the security and selecting the appropriate cross times based on the last analyzed cross time. For example, cross times for the security may be determined via a MySQL database command similar to the following:

SELECT assetCrossTimes
FROM cross_info
WHERE asset_ID = “AAPL”;

A determination may be made at 1009 whether there remain cross times to analyze. In one implementation, each of the cross times in the set may be analyzed. If there remain cross times to analyze, the next cross time may be selected for analysis at 1013.

The venue associated with the selected cross time may be determined at 1017. In one implementation, the venue may be determined by querying a database to determine venues for the security and selecting the venue corresponding to the selected cross time (e.g., based on sequence position, such as the 5th venue for the 5th cross time). For example, venues for the security may be determined via a MySQL database command similar to the following:

SELECT assetCrossVenues
FROM cross_info
WHERE asset_ID = “AAPL”;

A set of markout buckets for the selected cross time may be determined at 1021. In one implementation, a configuration setting may specify the set of markout buckets to use for analysis. For example, the configuration setting may specify that 1-second long markout buckets 30 seconds before and after a cross time (e.g., 60 markout buckets) should be used for analysis.

Trading velocity for the security may be analyzed at 1025. In one embodiment, manipulation may come with heightened trading or quoting activities. Accordingly, the number of trade tick and/or quote messages may be analyzed. In one implementation, the current count of trade tick and/or quote messages in the venue for each markout bucket in the set of markout buckets for the selected cross time may be determined. The reference count of trade tick and/or quote messages in the venue for each markout bucket during a reference time (e.g., similar time of day in another day, such as a week ago) may also be determined. If the ratio of current count of messages (e.g., trade tick messages; quote messages) is a threshold amount higher (e.g., as specified in a configuration setting, such as 5 or more times higher) than the reference count of messages (e.g., for at least a threshold number of markout buckets), a potential compromise may have occurred.

Price movement for the security may be analyzed at 1029. In one implementation, the current low/high price distribution (e.g., high price—low price) in the venue for each markout bucket in the set of markout buckets for the selected cross time may be determined. The reference low/high price distribution in the venue for each markout bucket during a reference time (e.g., similar time of day in another day, such as a week ago) may also be determined. If the current low/high price distribution is a threshold amount wider (e.g., as specified in a configuration setting, such as 2 or more times as wide) than the reference low/high price distribution (e.g., for at least a threshold number of markout buckets), a potential compromise may have occurred.

A determination may be made at 1033 whether a potential compromise was detected during trading velocity analysis and/or price movement analysis. If so, the selected cross time may be added to a set of potentially compromised cross times at 1037.

The set of potentially compromised cross times may be analyzed at 1041 to determine whether a compromise was detected. In one implementation, if a threshold number (e.g., at least 3 out of 15; at least 20%) of (e.g., consecutive) cross times is in the set of potentially compromised cross times, then a compromise is considered to have occurred.

If it is determined at 1045 that a compromise was detected, compromised broker dealers may be removed from the trusted broker dealers at 1049. In one implementation, broker dealers associated with transactions that occurred at cross times in the set of potentially compromised cross times may be considered to be compromised broker dealers (e.g., broker dealer 2 server 612 in FIG. 6D) and removed from the trusted broker dealers. New cross info for the security may be generated at 1053. In one implementation, the new cross info may be generated by the MKG component (e.g., using a new set of matched keys). The new cross info may be sent to the trusted broker dealers at 1057. For example, the new cross info may be sent via one or more new cross info notifications.

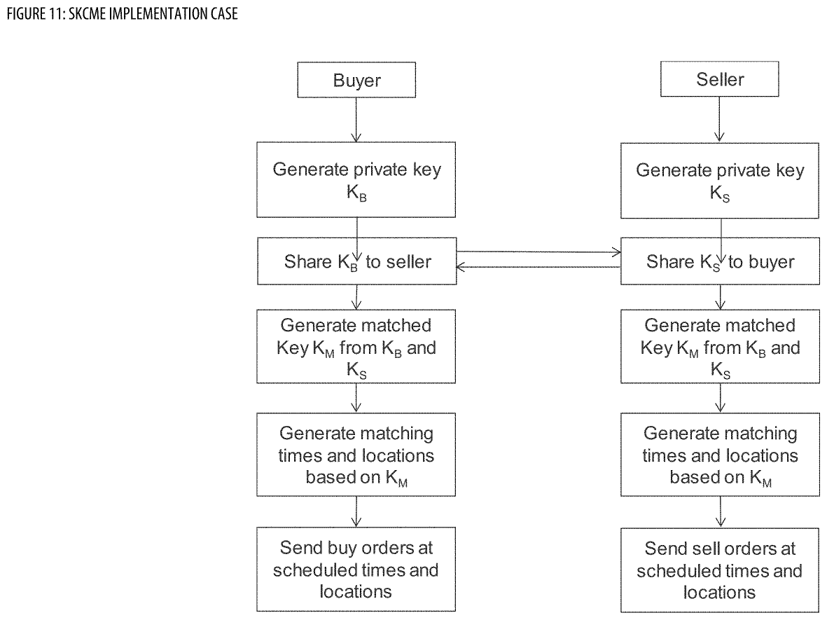

FIG. 11 shows implementation case(s) for the SKCME. In FIG. 11, an exemplary two counterparty methodology to facilitate secret key-based counterparty matching is illustrated.

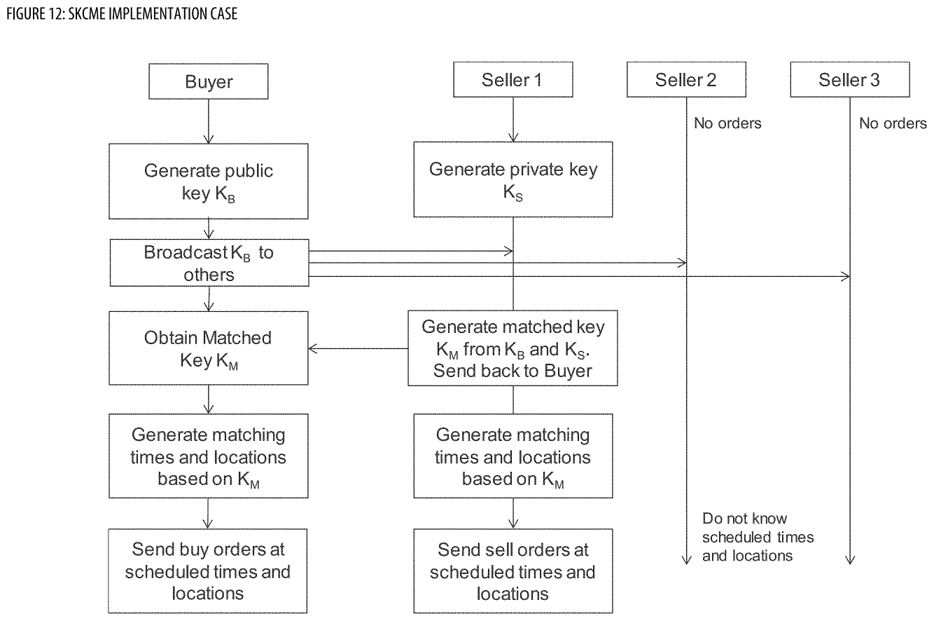

FIG. 12 shows implementation case(s) for the SKCME. In FIG. 12, an exemplary key broadcasting methodology to facilitate secret key-based counterparty matching is illustrated.

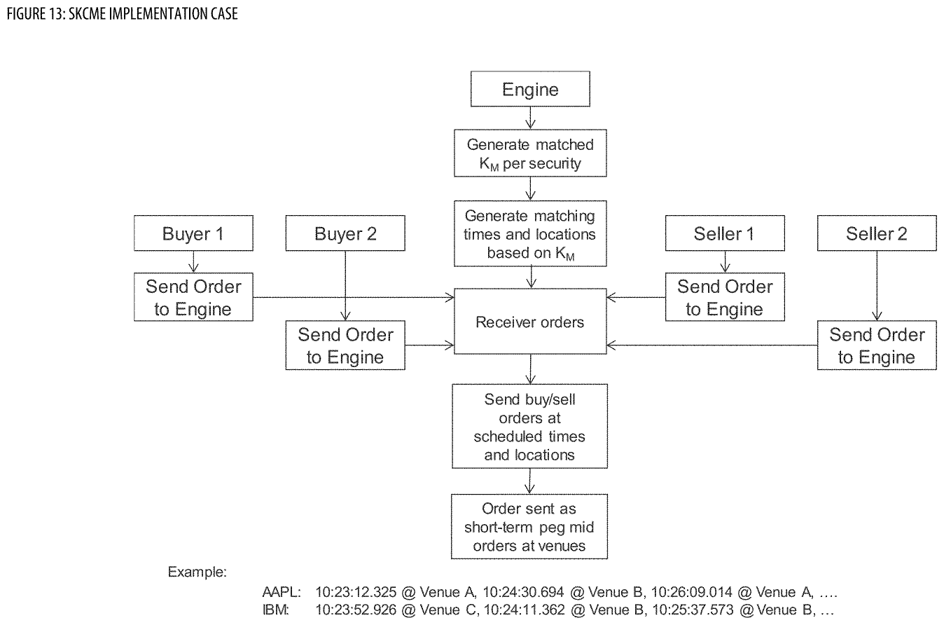

FIG. 13 shows implementation case(s) for the SKCME. In FIG. 13, an exemplary engine to facilitate crossing across multiple parties is illustrated.

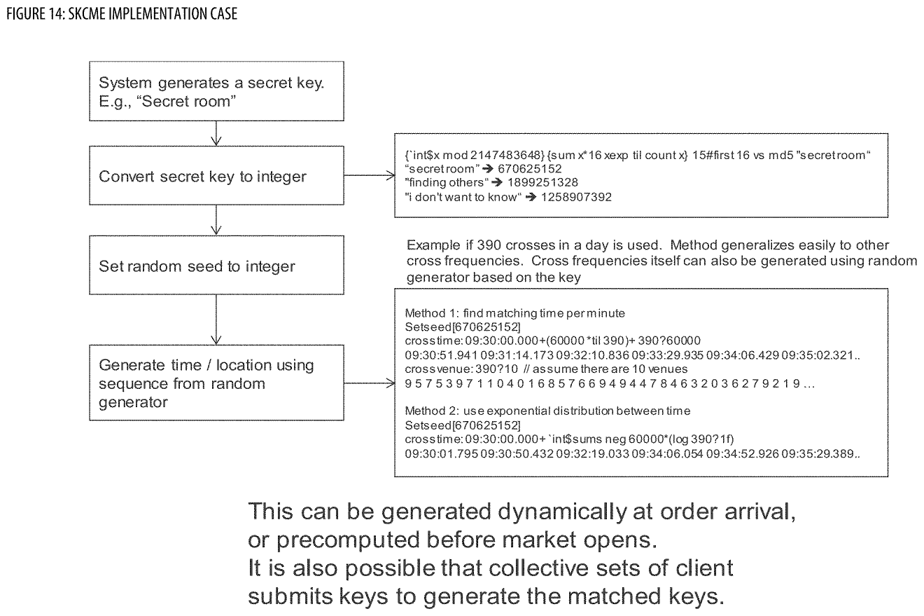

FIG. 14 shows implementation case(s) for the SKCME. In FIG. 14, an exemplary methodology for generating cross times and/or cross venues using a secret key is illustrated.

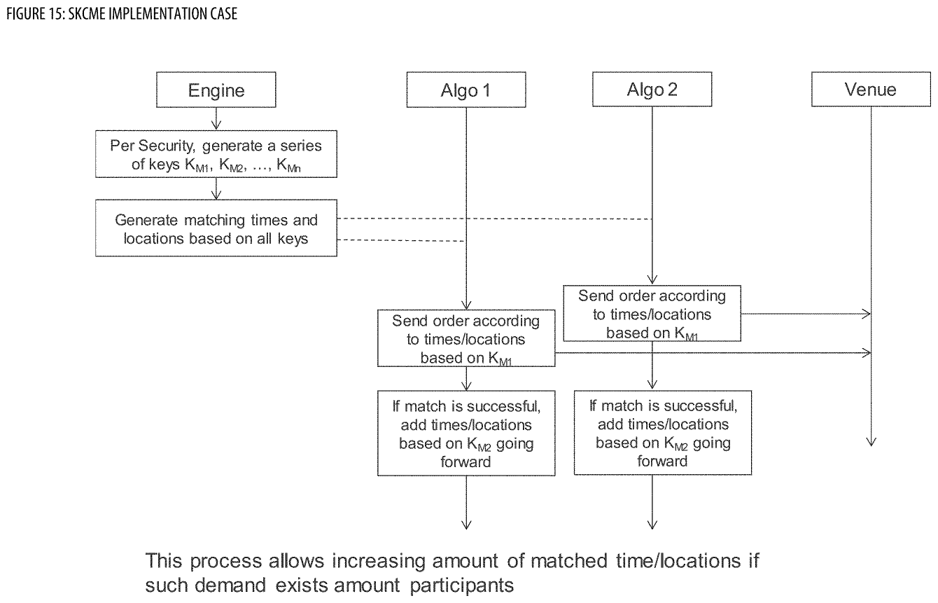

FIG. 15 shows implementation case(s) for the SKCME. In FIG. 15, an exemplary process to use multiple hierarchical keys per security is illustrated. Having additional crossing times may allow counterparties to use pricing discovery of market more comprehensively throughout the day, and avoid any potential pricing anomaly at a given time. For example, some clients may wish to execute their order according to volume weighted average price (VWAP) schedule, and having additional crossing times may provide lower tracking error with regard to the VWAP schedule. Use of hierarchical keys may help counterparties to increase crossing times. Initially, before counterparties discover each other, limited crossing times may be used to minimize interruption to other components in a trading algorithm. For example, the process in FIG. 15 allows for the system to produce secondary times/locations when there is significant match success. Hypothetically, if Kₘᵢ allows for a cross once every 10 minutes—a successful match can imply a higher than expected demand by participants on the platform. Generating an independent sequence via Kₘ₂ allows for the higher frequency to be masked with a newly generated random sequence.

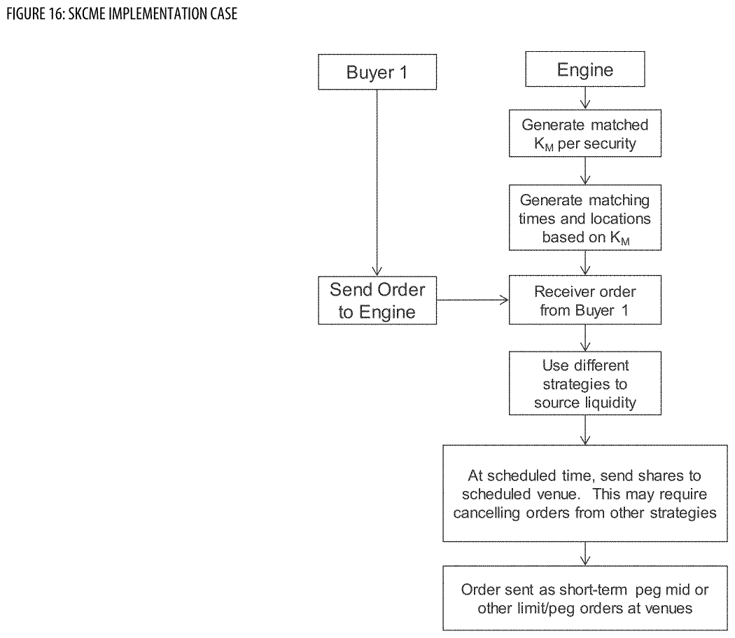

FIG. 16 shows implementation case(s) for the SKCME. In FIG. 16, an exemplary engine to facilitate counterparty matching while also using other algorithmic trading strategies is illustrated.

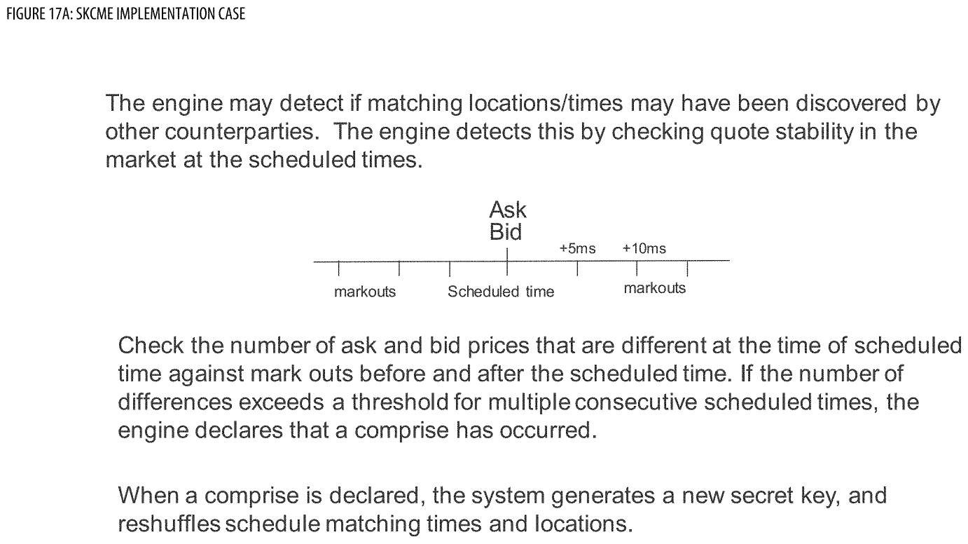

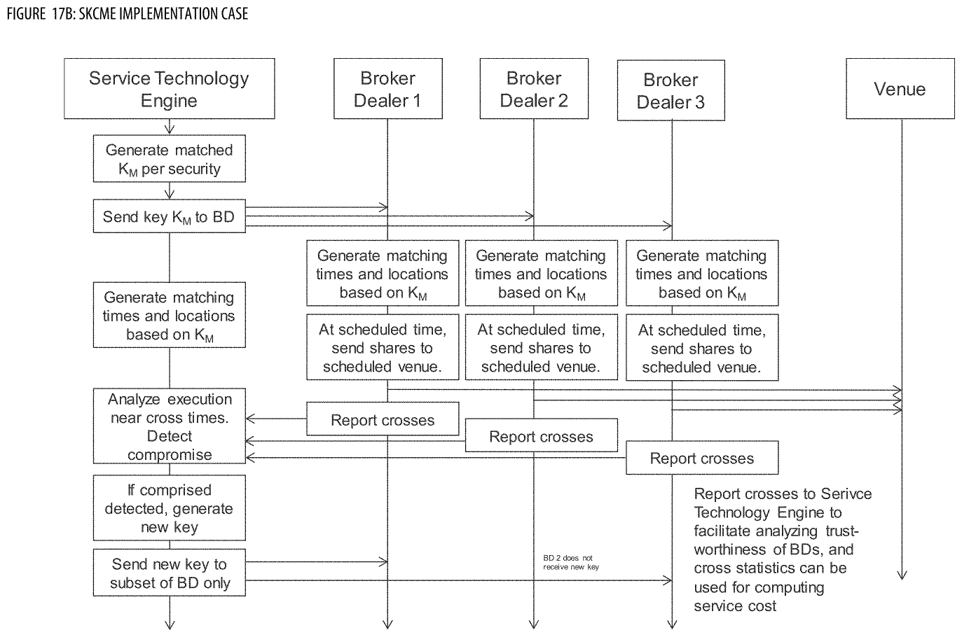

FIGS. 17A-B show implementation case(s) for the SKCME. In FIGS. 17A-B, exemplary compromise detection and/or mitigation embodiments are illustrated.

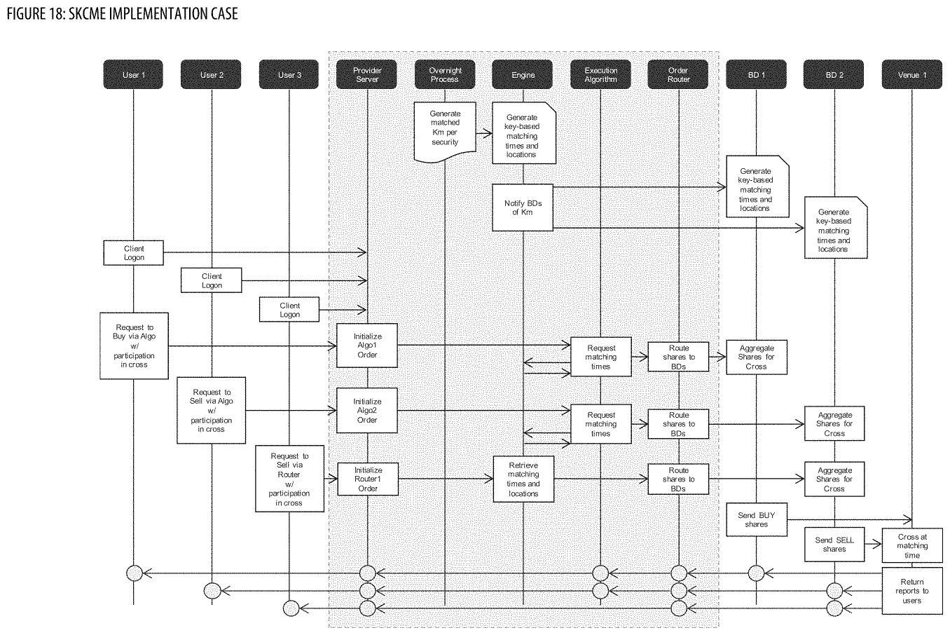

FIG. 18 shows implementation case(s) for the SKCME. In FIG. 18, an exemplary chronology for a given security to facilitate counterparty matching is illustrated.

### ADDITIONAL ALTERNATIVE EMBODIMENT EXAMPLES

The following alternative example embodiments provide a number of variations of some of the core principles already discussed for expanded color on the abilities of the SKCME.

Database (CDB)

1. Stores list of available markets (crossing locations)

1.1. This is configurable by product owners

2. Provides a mapping of destinations with a common mapping to the available markets

2.1. This is configurable by product owners

Overnight Jobs
1. Generate a master key based on time. With certain probability each day the system may reset this master key.
2. Given the day's master key, generate a random symbol specific key.
3. Given each day/symbol key, generate a sequence of 1 timestamp and corresponding location pair per minute, with timestamp accuracy out to the millisecond
4. Send a file to the shared database overnight before trading system startup

Database (CDB)

1. Read in ‘cross schedule’ file from overnight jobs with sequence of crossing times and locations per symbol

Algo (MTRX)

1. On startup validate the cross schedule for availability and expected structure
2. On receipt of an algo order, app may check if SKCME features are enabled
2.1. If SKCME features are enabled:
   2.1.1. Validate the symbol is available in the cross schedule.
      2.1.1.1. If the symbol is available:
         2.1.1.1.1. At the time of a scheduled cross, the algo may wake-up the SKCME component
         2.1.1.1.2. Upon waking up, the algo may check any additional criteria assigned to the component related to features including (but not limited to): Price, Liquidity, Demand, Schedule, Urgency, etc.
         2.1.1.1.3. If conditions are satisfied, the algo may send an appropriate number of shares to the Router with the location provided in a specific field (internal tag 7006). Otherwise, the algo may shutdown the SKCME component until the next crossing time.
   2.1.2. If the symbol is not available, the SKCME component of the algo may be disabled
2.2. If SKCME features are not enabled, no additional SKCME specific processing is performed

Router (FDLM)

1. Upon receipt of an order from the algos, the Router may check if tag 7006 is present.
1.1. If tag 7006 is present:
   1.1.1. Validate the specified location is in the database's list of available markets
      1.1.1.1. If it is available:
         1.1.1.1.1. Confirm at least one destination available in the Router's given configuration (called a Route ID) maps to the available common markets
         1.1.1.1.1.1. If they do, route the entire order as a short term pegged order for multiple milliseconds (sub-Second)
         1.1.1.1.1.1.1. At this point standard router protocol is in place to communicate executions and cancel/reject messages.
         1.1.1.1.1.2. If they do not, reject the order back to the algos
      1.1.1.2. If the location is not available, reject the order back to the algos
   1.2. If tag 7006 is not present, no additional SKCME specific processing is performed.

### SKCME Controller

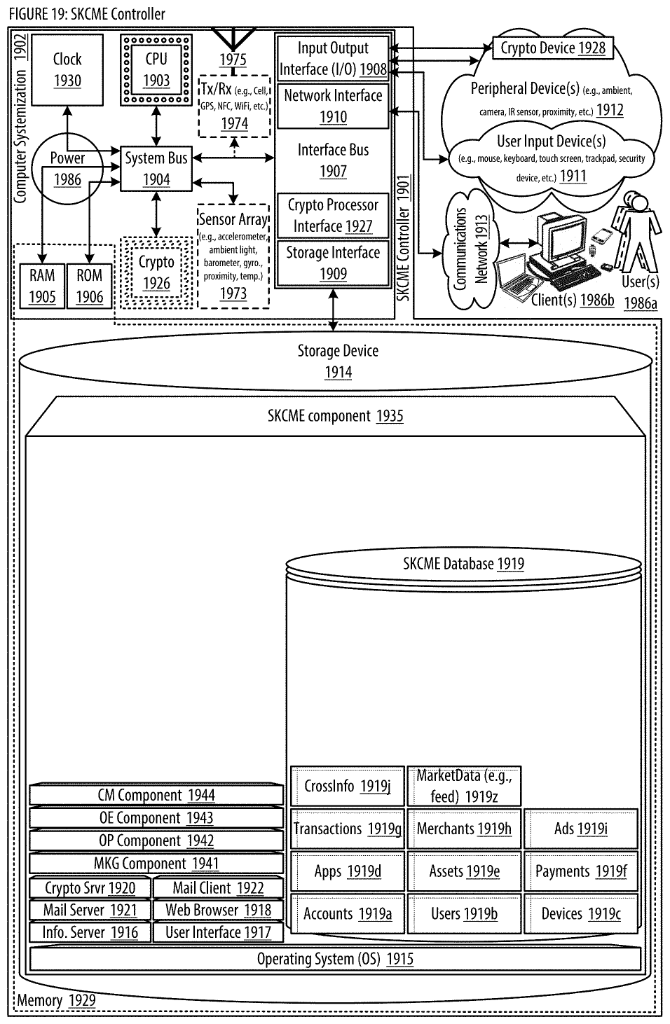

FIG. 19 shows a block diagram illustrating embodiments of a SKCME controller. In this embodiment, the SKCME controller 1901 may serve to aggregate, process, store, search, serve, identify, instruct, generate, match, and/or facilitate interactions with a computer through security technologies, and/or other related data.

Users, which may be people and/or other systems, may engage information technology systems (e.g., computers) to facilitate information processing. In turn, computers employ processors to process information; such processors 1903 may be referred to as central processing units (CPU). One form of processor is referred to as a microprocessor. CPUs use communicative circuits to pass binary encoded signals acting as instructions to allow various operations. These instructions may be operational and/or data instructions containing and/or referencing other instructions and data in various processor accessible and operable areas of memory 1929 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the SKCME controller 1901 may be connected to and/or communicate with entities such as, but not limited to: one or more users from peripheral devices 1912 (e.g., user input devices 1911); an optional cryptographic processor device 1928; and/or a communications network 1913.

Networks comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is referred to as a “node.” Networks are generally thought to facilitate the transfer of information from source points to destinations. A node specifically tasked with furthering the passage of information from a source to a destination is called a “router.” There are many forms of networks such as Local Area Networks (LANs), Pico networks, Wide Area Networks (WANs), Wireless Networks (WLANs), etc. For example, the Internet is, generally, an interconnection of a multitude of networks whereby remote clients and servers may access and interoperate with one another.

The SKCME controller 1901 may be based on computer systems that may comprise, but are not limited to, components such as: a computer systemization 1902 connected to memory 1929.

### Computer Systemization

A computer systemization 1902 may comprise a clock 1930, central processing unit (“CPU(s)” and/or “processor(s)” (these terms are used interchangeable throughout the disclosure unless noted to the contrary)) 1903, a memory 1929 (e.g., a read only memory (ROM) 1906, a random access memory (RAM) 1905, etc.), and/or an interface bus 1907, and most frequently, although not necessarily, are all interconnected and/or communicating through a system bus 1904 on one or more (mother)board(s) 1902 having conductive and/or otherwise transportive circuit pathways through which instructions (e.g., binary encoded signals) may travel to effectuate communications, operations, storage, etc. The computer systemization may be connected to a power source 1986; e.g., optionally the power source may be internal. Optionally, a cryptographic processor 1926 may be connected to the system bus. In another embodiment, the cryptographic processor, transceivers (e.g., ICs) 1974, and/or sensor array (e.g., accelerometer, altimeter, ambient light, barometer, global positioning system (GPS) (thereby allowing SKCME controller to determine its location), gyroscope, magnetometer, pedometer, proximity, ultra-violet sensor, etc.) 1973 may be connected as either internal and/or external peripheral devices 1912 via the interface bus I/O 1908 (not pictured) and/or directly via the interface bus 1907. In turn, the transceivers may be connected to antenna(s) 1975, thereby effectuating wireless transmission and reception of various communication and/or sensor protocols; for example the antenna(s) may connect to various transceiver chipsets (depending on deployment needs), including: Broadcom® BCM4329FKUBG transceiver chip (e.g., providing 802.11n, Bluetooth 2.1+EDR, FM, etc.); a Broadcom® BCM4752 GPS receiver with accelerometer, altimeter, GPS, gyroscope, magnetometer; a Broadcom® BCM4335 transceiver chip (e.g., providing 2G, 3G, and 4G long-term evolution (LTE) cellular communications; 802.11ac, Bluetooth 4.0 low energy (LE) (e.g., beacon features)); a Broadcom® BCM43341 transceiver chip (e.g., providing 2G, 3G and 4G LTE cellular communications; 802.11 g/, Bluetooth 4.0, near field communication (NFC), FM radio); an Infineon Technologies® X-Gold 618-PMB9800 transceiver chip (e.g., providing 2G/3G HSDPA/HSUPA communications); a MediaTek® MT6620 transceiver chip (e.g., providing 802.11a/ac/b/g/n, Bluetooth 4.0 LE, FM, GPS; a Lapis Semiconductor® ML8511 UV sensor; a maxim integrated MAX44000 ambient light and infrared proximity sensor; a Texas Instruments® WiLink WL1283 transceiver chip (e.g., providing 802.11n, Bluetooth 3.0, FM, GPS); and/or the like. The system clock may have a crystal oscillator and generates a base signal through the computer systemization's circuit pathways. The clock may be coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. The CPU is often packaged in a number of formats varying from large supercomputer(s) and mainframe(s) computers, down to mini computers, servers, desktop computers, laptops, thin clients (e.g., Chromebooks®), netbooks, tablets (e.g., Android®, iPads®, and Windows® tablets, etc.), mobile smartphones (e.g., Android®, iPhones®, Nokia®, Palm® and Windows® phones, etc.), wearable device(s) (e.g., watches, glasses, goggles (e.g., Google Glass), etc.), and/or the like. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 1929 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon®, Duron® and/or Opteron®; Apple's® A series of processors (e.g., A5, A6, A7, A8, etc.); ARM's® application, embedded and secure processors; IBM® and/or Motorola's DragonBall® and PowerPC®; IBM's® and Sony's® Cell processor; Intel's® 80X86 series (e.g., 80386, 80486), Pentium®, Celeron®, Core (2) Duo®, i series (e.g., i3, i5, i7, etc.), Itanium®, Xeon®, and/or XScale®; Motorola's® 680X0 series (e.g., 68020, 68030, 68040, etc.); and/or the like processor(s). The CPU interacts with memory through instruction passing through conductive and/or transportive conduits (e.g., (printed) electronic and/or optic circuits) to execute stored instructions (i.e., program code) according to various data processing techniques. Such instruction passing facilitates communication within the SKCME controller and beyond through various interfaces. Should processing requirements dictate a greater amount speed and/or capacity, distributed processors (e.g., see Distributed SKCME below), mainframe, multi-core, parallel, and/or super-computer architectures may similarly be employed. Alternatively, should deployment requirements dictate greater portability, smaller mobile devices (e.g., Personal Digital Assistants (PDAs)) may be employed.

Depending on the particular implementation, features of the SKCME may be achieved by implementing a microcontroller such as CAST's® R8051XC2 microcontroller; Intel's® MCS 51 (i.e., 8051 microcontroller); and/or the like. Also, to implement certain features of the SKCME, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the SKCME component collection (distributed or otherwise) and/or features may be implemented via the microprocessor and/or via embedded components; e.g., via ASIC, coprocessor, DSP, FPGA, and/or the like. Alternately, some implementations of the SKCME may be implemented with embedded components that are configured and used to achieve a variety of features or signal processing.

Depending on the particular implementation, the embedded components may include software solutions, hardware solutions, and/or some combination of both hardware/software solutions. For example, SKCME features discussed herein may be achieved through implementing FPGAs, which are a semiconductor devices containing programmable logic components called “logic blocks”, and programmable interconnects, such as the high performance FPGA Virtex® series and/or the low cost Spartan® series manufactured by Xilinx®. Logic blocks and interconnects can be programmed by the customer or designer, after the FPGA is manufactured, to implement any of the SKCME features. A hierarchy of programmable interconnects allow logic blocks to be interconnected as needed by the SKCME system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the SKCME may be developed on FPGAs and then migrated into a fixed version that more resembles ASIC implementations. Alternate or coordinating implementations may migrate SKCME controller features to a final ASIC instead of or in addition to FPGAs. Depending on the implementation all of the aforementioned embedded components and microprocessors may be considered the “CPU” and/or “processor” for the SKCME.

### Power Source

The power source 1986 may be of any various form for powering small electronic circuit board devices such as the following power cells—alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 1986 is connected to at least one of the interconnected subsequent components of the SKCME thereby providing an electric current to all subsequent components. In one example, the power source 1986 is connected to the system bus component 1904. In an alternative embodiment, an outside power source 1986 is provided through a connection across the I/O 1908 interface. For example, a USB and/or IEEE 1394 connection carries both data and power across the connection and is therefore a suitable source of power.

### Interface Adapters

Interface bus(ses) 1907 may accept, connect, and/or communicate to a number of interface adapters, variously although not necessarily in the form of adapter cards, such as but not limited to: input output interfaces (I/O) 1908, storage interfaces 1909, network interfaces 1910, and/or the like. Optionally, cryptographic processor interfaces 1927 similarly may be connected to the interface bus. The interface bus provides for the communications of interface adapters with one another as well as with other components of the computer systemization. Interface adapters are adapted for a compatible interface bus. Interface adapters variously connect to the interface bus via a slot architecture. Various slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 1909 may accept, communicate, and/or connect to a number of storage devices such as, but not limited to: storage devices 1914, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 1910 may accept, communicate, and/or connect to a communications network 1913. Through a communications network 1913, the SKCME controller is accessible through remote clients 1933b (e.g., computers with web browsers) by users 1933a. Network interfaces may employ connection protocols such as, but not limited to: direct connect, Ethernet (thick, thin, twisted pair 10/100/1000/10000 Base T, and/or the like), Token Ring, wireless connection such as IEEE 802.11a-x, and/or the like. Should processing requirements dictate a greater amount speed and/or capacity, distributed network controllers (e.g., see Distributed SKCME below), architectures may similarly be employed to pool, load balance, and/or otherwise decrease/increase the communicative bandwidth required by the SKCME controller. A communications network may be any one and/or the combination of the following: a direct interconnection; the Internet; Interplanetary Internet (e.g., Coherent File Distribution Protocol (CFDP), Space Communications Protocol Specifications (SCPS), etc.); a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a cellular, WiFi, Wireless Application Protocol (WAP), I-mode, and/or the like); and/or the like. A network interface may be regarded as a specialized form of an input output interface. Further, multiple network interfaces 1910 may be used to engage with various communications network types 1913. For example, multiple network interfaces may be employed to allow for the communication over broadcast, multicast, and/or unicast networks.

Input Output interfaces (I/O) 1908 may accept, communicate, and/or connect to user, peripheral devices 1912 (e.g., input devices 1911), cryptographic processor devices 1928, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; touch interfaces: capacitive, optical, resistive, etc. displays; video interface: Apple Desktop Connector (ADC), BNC, coaxial, component, composite, digital, Digital Visual Interface (DVI), (mini) displayport, high-definition multimedia interface (HDMI), RCA, RF antennae, S-Video, VGA, and/or the like; wireless transceivers: 802.11a/ac/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One output device may include a video display, which may comprise a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. The video interface provides the composited video information through a video connection interface that accepts a video display interface (e.g., an RCA composite video connector accepting an RCA composite video cable; a DVI connector accepting a DVI display cable, etc.).

Peripheral devices 1912 may be connected and/or communicate to I/O and/or other facilities of the like such as network interfaces, storage interfaces, directly to the interface bus, system bus, the CPU, and/or the like. Peripheral devices may be external, internal and/or part of the SKCME controller. Peripheral devices may include: antenna, audio devices (e.g., line-in, line-out, microphone input, speakers, etc.), cameras (e.g., gesture (e.g., Microsoft Kinect) detection, motion detection, still, video, webcam, etc.), dongles (e.g., for copy protection, ensuring secure transactions with a digital signature, and/or the like), external processors (for added capabilities; e.g., crypto devices 528), force-feedback devices (e.g., vibrating motors), infrared (IR) transceiver, network interfaces, printers, scanners, sensors/sensor arrays and peripheral extensions (e.g., ambient light, GPS, gyroscopes, proximity, temperature, etc.), storage devices, transceivers (e.g., cellular, GPS, etc.), video devices (e.g., goggles, monitors, etc.), video sources, visors, and/or the like. Peripheral devices often include types of input devices (e.g., cameras).

User input devices 1911 often are a type of peripheral device 512 (see above) and may include: card readers, dongles, finger print readers, gloves, graphics tablets, joysticks, keyboards, microphones, mouse (mice), remote controls, security/biometric devices (e.g., fingerprint reader, iris reader, retina reader, etc.), touch screens (e.g., capacitive, resistive, etc.), trackballs, trackpads, styluses, and/or the like.

It should be noted that although user input devices and peripheral devices may be employed, the SKCME controller may be embodied as an embedded, dedicated, and/or monitor-less (i.e., headless) device, wherein access would be provided over a network interface connection.

Cryptographic units such as, but not limited to, microcontrollers, processors 1926, interfaces 1927, and/or devices 1928 may be attached, and/or communicate with the SKCME controller. A MC68HC16 microcontroller, manufactured by Motorola, Inc.®, may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other specialized cryptographic processors include: Broadcom's® CryptoNetX and other Security Processors; nCipher's® nShield; SafeNet's® Luna PCI (e.g., 7100) series; Semaphore Communications'® 40 MHz Roadrunner 184; Sun's® Cryptographic Accelerators (e.g., Accelerator 6000 PCIe Board, Accelerator 500 Daughtercard); Via Nano® Processor (e.g., L2100, L2200, U2400) line, which is capable of performing 500+MB/s of cryptographic instructions; VLSI Technology's® 33 MHz 6868; and/or the like.

### Memory

Generally, any mechanization and/or embodiment allowing a processor to affect the storage and/or retrieval of information is regarded as memory 1929. However, memory is a fungible technology and resource, thus, any number of memory embodiments may be employed in lieu of or in concert with one another. It is to be understood that the SKCME controller and/or a computer systemization may employ various forms of memory 1929. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In one configuration, memory 1929 will include ROM 1906, RAM 1905, and a storage device 1914. A storage device 1914 may be any various computer system storage. Storage devices may include: an array of devices (e.g., Redundant Array of Independent Disks (RAID)); a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); RAM drives; solid state memory devices (USB memory, solid state drives (SSD), etc.); other processor-readable storage mediums; and/or other devices of the like. Thus, a computer systemization generally requires and makes use of memory.

### Component Collection

The memory 1929 may contain a collection of program and/or database components and/or data such as, but not limited to: operating system component(s) 1915 (operating system); information server component(s) 1916 (information server); user interface component(s) 1917 (user interface); Web browser component(s) 1918 (Web browser); database(s) 1919; mail server component(s) 1921; mail client component(s) 1922; cryptographic server component(s) 1920 (cryptographic server); the SKCME component(s) 1935; and/or the like (i.e., collectively a component collection). These components may be stored and accessed from the storage devices and/or from storage devices accessible through an interface bus. Although unconventional program components such as those in the component collection may be stored in a local storage device 1914, they may also be loaded and/or stored in memory such as: peripheral devices, RAM, remote storage facilities through a communications network, ROM, various forms of memory, and/or the like.

### Operating System

The operating system component 1915 is an executable program component facilitating the operation of the SKCME controller. The operating system may facilitate access of I/O, network interfaces, peripheral devices, storage devices, and/or the like. The operating system may be a highly fault tolerant, scalable, and secure system such as: Apple's Macintosh OS X (Server) and macOS®; AT&T Plan 9®; Be OS®; Blackberry's QNX®; Google's Chrome®; Microsoft's Windows® 7/8/10; Unix and Unix-like system distributions (such as AT&T's UNIX®; Berkley Software Distribution (BSD)® variations such as FreeBSD®, NetBSD, OpenBSD, and/or the like; Linux distributions such as Red Hat, Ubuntu, and/or the like); and/or the like operating systems. However, more limited and/or less secure operating systems also may be employed such as Apple Macintosh OS® (i.e., versions 1-9), IBM OS/2®, Microsoft DOS®, Microsoft Windows 2000/2003/3.1/95/98/CE/Millenium/Mobile/NT/Vista/XP (Server)®, Palm OS®, and/or the like. Additionally, for robust mobile deployment applications, mobile operating systems may be used, such as: Apple's iOS®; China Operating System COS®; Google's Android®; Microsoft Windows RT/Phone®; Palm's WebOS®; Samsung/Intel's Tizen®; and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the SKCME controller to communicate with other entities through a communications network 1913. Various communication protocols may be used by the SKCME controller as a subcarrier transport mechanism for interaction, such as, but not limited to: multicast, TCP/IP, UDP, unicast, and/or the like.

### Information Server

An information server component 1916 is a stored program component that is executed by a CPU. The information server may be an Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects®, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM)®, Application Exchange (APEX), ICQ, Internet Relay Chat (IRC), Microsoft Network (MSN) Messenger® Service, Presence and Instant Messaging Protocol (PRIM), Internet Engineering Task Force's® (IETF's) Session Initiation Protocol (SIP), SIP for Instant Messaging and Presence Leveraging Extensions (SIMPLE), open XML-based Extensible Messaging and Presence Protocol (XMPP) (i.e., Jabber® or Open Mobile Alliance's (OMA's) Instant Messaging and Presence Service (IMPS)), Yahoo! Instant Messenger® Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the SKCME controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the SKCME database 1919, operating systems, other program components, user interfaces, Web browsers, and/or the like.

Access to the SKCME database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the SKCME. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in SQL by instantiating a search string with the proper join/select commands based on the tagged text entries, wherein the resulting command is provided over the bridge mechanism to the SKCME as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as buttons, check boxes, cursors, menus, scrollers, and windows (collectively referred to as widgets) similarly facilitate the access, capabilities, operation, and display of data and computer hardware and operating system resources, and status. Operation interfaces are called user interfaces. Graphical user interfaces (GUIs) such as the Apple's iOS®, Macintosh Operating System's Aqua®; IBM's OS/2®; Google's Chrome® (e.g., and other webbrowser/cloud based client OSs); Microsoft's Windows® varied UIs 2000/2003/3.1/95/98/CE/Millenium/Mobile/NT/Vista/XP (Server) (i.e., Aero, Surface, etc.); Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface®, any of which may be used and) provide a baseline and means of accessing and displaying information graphically to users.

A user interface component 1917 is a stored program component that is executed by a CPU. The user interface may be a graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 1918 is a stored program component that is executed by a CPU. The Web browser may be a hypertext viewing application such as Apple's (mobile) Safari®, Google's Chrome®, Microsoft Internet Explorer®, Mozilla's Firefox®, Netscape Navigator®, and/or the like. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox®, Safari® Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the SKCME enabled nodes. The combined application may be nugatory on systems employing Web browsers.

### Mail Server

A mail server component 1921 is a stored program component that is executed by a CPU 1903. The mail server may be an Internet mail server such as, but not limited to: dovecot, Courier IMAP, Cyrus IMAP, Maildir, Microsoft Exchange, sendmail, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects®, and/or the like. The mail server may support communications protocols such as, but not limited to: Internet message access protocol (IMAP), Messaging Application Programming Interface (MAPI)/Microsoft Exchange, post office protocol (POPS), simple mail transfer protocol (SMTP), and/or the like. The mail server can route, forward, and process incoming and outgoing mail messages that have been sent, relayed and/or otherwise traversing through and/or to the SKCME. Alternatively, the mail server component may be distributed out to mail service providing entities such as Google's® cloud services (e.g., Gmail and notifications may alternatively be provided via messenger services such as AOL's Instant Messenger®, Apple's iMessage®, Google Messenger®, SnapChat®, etc.).

Access to the SKCME mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 1922 is a stored program component that is executed by a CPU 1903. The mail client may be a mail viewing application such as Apple Mail®, Microsoft Entourage®, Microsoft Outlook®, Microsoft Outlook Express®, Mozilla®, Thunderbird®, and/or the like. Mail clients may support a number of transfer protocols, such as: IMAP, Microsoft Exchange, POPS, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 1920 is a stored program component that is executed by a CPU 1903, cryptographic processor 1926, cryptographic processor interface 1927, cryptographic processor device 1928, and/or the like. Cryptographic processor interfaces will allow for expedition of encryption and/or decryption requests by the cryptographic component; however, the cryptographic component, alternatively, may run on a CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), Transport Layer Security (TLS), and/or the like. Employing such encryption security protocols, the SKCME may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for a digital audio file. A cryptographic component may communicate to and/or with other components in a component collection, including itself, and/or facilities of the like. The cryptographic component supports encryption schemes allowing for the secure transmission of information across a communications network to allow the SKCME component to engage in secure transactions if so desired. The cryptographic component facilitates the secure accessing of resources on the SKCME and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The SKCME Database

The SKCME database component 1919 may be embodied in a database and its stored data. The database is a stored program component, which is executed by the CPU; the stored program component portion configuring the CPU to process the stored data. The database may be a fault tolerant, relational, scalable, secure database such as MySQL®, Oracle®, Sybase®, etc. may be used. Additionally, optimized fast memory and distributed databases such as IBM's Netezza®, MongoDB's MongoDB®, opensource Hadoop®, opensource VoltDB, SAP's Hana®, etc. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. Alternative key fields may be used from any of the fields having unique value sets, and in some alternatives, even non-unique values in combinations with other fields. More precisely, they uniquely identify rows of a table on the “one” side of a one-to-many relationship.

Alternatively, the SKCME database may be implemented using various other data-structures, such as an array, hash, (linked) list, struct, structured text file (e.g., XML), table, and/or the like. Such data-structures may be stored in memory and/or in (structured) files. In another alternative, an object-oriented database may be used, such as Frontier™, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the SKCME database is implemented as a data-structure, the use of the SKCME database 1919 may be integrated into another component such as the SKCME component 1935. Also, the database may be implemented as a mix of data structures, objects, and relational structures. Databases may be consolidated and/or distributed in countless variations (e.g., see Distributed SKCME below). Portions of databases, e.g., tables, may be exported and/or imported and thus decentralized and/or integrated.

In one embodiment, the database component 1919 includes several tables 1919a-z:

An accounts table 1919a includes fields such as, but not limited to: an accountID, accountOwnerID, accountContactID, asseaDs, deviceIDs, paymentIDs, transactionIDs, userIDs, accountType (e.g., agent, entity (e.g., corporate, non-profit, partnership, etc.), individual, etc.), accountCreationDate, accountUpdateDate, accountName, accountNumber, routingNumber, linkWalletsID, accountPrioritAccaountRatio, accountAddress, accountState, accountZIPcode, accountCountry, accountEmail, accountPhone, accountAuthKey, accountIPaddress, accountURLAccessCode, accountPortNo, accountAuthorizationCode, accountAcces sPrivileges, accountPreferences, accoun tRestrictions, and/or the like;

A users table 1919b includes fields such as, but not limited to: a userID, userSSN, taxID, userContactID, accountID, assetIDs, deviceIDs, paymentIDs, transactionIDs, userType (e.g., agent, entity (e.g., corporate, non-profit, partnership, etc.), individual, etc.), namePrefix, firstName, middleName, lastName, nameSuffix, DateOfBirth, userAge, userName, userEmail, userSocialAccountID, contactType, contactRelationship, userPhone, userAddress, userCity, userState, userZIPCode, userCountry, userAuthorizationCode, userAccessPrivilges, userPreferences, userRestrictions, and/or the like (the user table may support and/or track multiple entity accounts on a SKCME);

An devices table 1919c includes fields such as, but not limited to: deviceID, sensorIDs, accountID, assetIDs, paymentIDs, deviceType, deviceName, deviceManufacturer, deviceModel, deviceVersion, deviceSerialNo, deviceIPaddress, deviceMACaddress, device_ECID, deviceUUID, deviceLocation, deviceCertificate, deviceOS, appIDs, deviceResources, deviceVersion, authKey, deviceSecureKey, walletAppInstalledFlag, deviceAccessPrivileges, devicePreferences, deviceRestrictions, hardware_config, software_config, storage_location, sensor_value, pin_reading, data_length, channel_requirement, sensor_name, sensor_model_no, sensor_manufacturer, sensor_type, sensor_serial_number, sensor_power_requirement, device_power_requirement, location, sensor_associated_tool, sensor_dimensions, device_dimensions, sensor_communications_type, device_communications_type, power_percentage, power_condition, temperature_setting, speed_adjust, hold_duration, part_actuation, and/or the like. Device table may, in some embodiments, include fields corresponding to one or more Bluetooth profiles, such as those published at https://www.bluetooth.org/en-us/specification/adopted-specifications, and/or other device specifications, and/or the like;

An apps table 1919d includes fields such as, but not limited to: appID, appName, appType, appDependencies, accountID, deviceIDs, transactionID, userID, appStoreAuthKey, appStoreAccountID, appStoreIPaddress, appStoreURLaccessCode, appStorePortNo, appAccessPrivileges, appPreferences, appRestrictions, portNum, access_API_call, linked_wallets_list, and/or the like;

An assets table 1919e includes fields such as, but not limited to: assetID, accountID, userID, distributorAccountID, distributorPaymentID, distributorOnwerID, assetOwnerID, assetType, assetSourceDeviceID, assetSourceDeviceType, assetSourceDeviceName, assetSourceDistributionChannelID, assetSourceDistributionChannelType, assetSourceDistributionChannelName, assetTargetChannelID, assetTargetChannelType, assetTargetChannelName, assetName, assetSeriesName, assetSeriesSeason, assetSeriesEpisode, assetCode, assetQuantity, assetCost, assetPrice, assetValue, assetManufactuer, assetModelNo, assetSerialNo, assetLocation, assetAddres s, assetState, assetZIPcode, assetState, assetCountry, assetEmail, assetIPaddress, assetURLaccessCode, assetOwnerAccountID, sub scriptionIDs, assetAuthroizationCode, assetAccessPrivileges, assetPreferences, assetRestrictions, assetAPI, assetAPIconnectionAddress, and/or the like;

A payments table 1919f includes fields such as, but not limited to: paymentID, accountID, userID, couponID, couponValue, couponConditions, couponExpiration, paymentType, paymentAccountNo, paymen tAccountName, paymentAccoun tAuthorizationCodes, paymentExpirationDate, paymentCCV, paymentRoutingNo, paymentRoutingType, paymentAddress, paymentState, paymentZIPcode, paymentCountry, paymentEmail, paymentAuthKey, paymentIPaddress, paymentURLaccessCode, paymentPortNo, paymentAccessPrivileges, paymentPreferences, payementRestric Lions, and/or the like;

An transactions table 1919g includes fields such as, but not limited to: transactionID, accountID, assetIDs, deviceIDs, paymentIDs, transactionIDs, userID, merchantID, transactionType, transactionDate, transactionTime, transactionAmount, transactionQuantity, transactionDetails, productsList, productType, productTitle, productsSummary, productParamsList, transactionNo, transactionAcces sPrivileges, transactionPreferences, transactionRestrictions, merchantAuthKey, merchantAuthCode, and/or the like;

An merchants table 1919h includes fields such as, but not limited to: merchantID, merchantTaxID, merchanteName, merchantContactUserID, accountID, is suerID, acquirerID, merchantEmail, merchantAddress, merchantState, merchantZIPcode, merchantCountry, merchantAuthKey, merchantlPaddress, portNum, merchantURLaccessCode, merchantPortNo, merchantAcces sPrivileges, merchantPreferences, merchantRestrictions, and/or the like;

An ads table 1919i includes fields such as, but not limited to: adID, advertiserID, adMerchantID, adNetworkID, adName, adTags, advertiserName, adSponsor, adTime, adGeo, adAttributes, adFormat, adProduct, adText, adMedia, adMediaID, adChannelID, adTagTime, adAudioSignature, adHash, adTemplateID, adTemplateData, adSourceID, adSourceName, adSourceServerlP, adSourceURL, adSourceSecurityProtocol, adSourceFTP, adAuthKey, adAccessPrivileges, adPreferences, adRestrictions, adNetworkXchangeID, adNetworkXchangeName, adNetworkXchangeCost, adNetworkXchangeMetricType (e.g., CPA, CPC, CPM, CTR, etc.), adNetworkXchangeMetricValue, adNetworkXchangeServer, adNetworkXchangePortNumber, publisherID, publisherAddress, publisherURL, publisherTag, publisherIndustry, publisherName, publisherDescription, siteDomain, siteURL, siteContent, siteTag, siteContext, sitelmpression, siteVisits, siteHeadline, sitePage, siteAdPrice, sitePlacement, sitePosition, bidID, bidExchange, bidOS, bidTarget, bidTimestamp, bidPrice, bidlmpressionID, bidType, bidScore, adType (e.g., mobile, desktop, wearable, largescreen, interstitial, etc.), assetID, merchantID, deviceID, userID, accountID, impressionID, impressionOS, impressionTimeStamp, impressionGeo, impressionAction, impressionType, impressionPublisherID, impressionPublisherURL, and/or the like;

A cross_info table 1919j includes fields such as, but not limited to: asset_ID, assetClientKeys, assetMatchedKey, assetCros sFrequency, assetCros sTimes, assetCrossVenues, trustedBrokerDealers, assetAssociatedPrivateKey, and/or the like;

A market_data table 1919z includes fields such as, but not limited to: market_data_feed_ID, asset_ID, asset_symbol, asset_name, spot_price, bid_price, ask_price, venue, and/or the like; in one embodiment, the market data table is populated through a market data feed (e.g., Bloomberg's PhatPipe®, Consolidated Quote System® (CQS), Consolidated Tape Association® (CTA), Consolidated Tape System® (CTS), Dun & Bradstreet®, OTC Montage Data Feed® (OMDF), Reuter's Tib®, Triarch®, US equity trade and quote market data®, Unlisted Trading Privileges® (UTP) Trade Data Feed® (UTDF), UTP Quotation Data Feed® (UQDF), and/or the like feeds, e.g., via ITC 2.1 and/or respective feed protocols), for example, through Microsoft's® Active Template Library and Dealing Object Technology's real-time toolkit Rtt.Multi.

In one embodiment, the SKCME database may interact with other database systems. For example, employing a distributed database system, queries and data access by search SKCME component may treat the combination of the SKCME database, an integrated data security layer database as a single database entity (e.g., see Distributed SKCME below).

In one embodiment, user programs may contain various user interface primitives, which may serve to update the SKCME. Also, various accounts may require custom database tables depending upon the environments and the types of clients the SKCME may need to serve. It should be noted that any unique fields may be designated as a key field throughout. In an alternative embodiment, these tables have been decentralized into their own databases and their respective database controllers (i.e., individual database controllers for each of the above tables). Employing various data processing techniques, one may further distribute the databases over several computer systemizations and/or storage devices. Similarly, configurations of the decentralized database controllers may be varied by consolidating and/or distributing the various database components 1919a-z. The SKCME may be configured to keep track of various settings, inputs, and parameters via database controllers.

The SKCME database may communicate to and/or with other components in a component collection, including itself, and/or facilities of the like. Most frequently, the SKCME database communicates with the SKCME component, other program components, and/or the like. The database may contain, retain, and provide information regarding other nodes and data.

### The SKCMEs

The SKCME component 1935 is a stored program component that is executed by a CPU. In one embodiment, the SKCME component incorporates any and/or all combinations of the aspects of the SKCME that was discussed in the previous figures. As such, the SKCME affects accessing, obtaining and the provision of information, services, transactions, and/or the like across various communications networks. The features and embodiments of the SKCME discussed herein increase network efficiency by reducing data transfer requirements the use of more efficient data structures and mechanisms for their transfer and storage. As a consequence, more data may be transferred in less time, and latencies with regard to transactions, are also reduced. In many cases, such reduction in storage, transfer time, bandwidth requirements, latencies, etc., will reduce the capacity and structural infrastructure requirements to support the SKCME's features and facilities, and in many cases reduce the costs, energy consumption/requirements, and extend the life of SKCME's underlying infrastructure; this has the added benefit of making the SKCME more reliable. Similarly, many of the features and mechanisms are designed to be easier for users to use and access, thereby broadening the audience that may enjoy/employ and exploit the feature sets of the SKCME; such ease of use also helps to increase the reliability of the SKCME. In addition, the feature sets include heightened security as noted via the Cryptographic components 1920, 1926, 1928 and throughout, making access to the features and data more reliable and secure

The SKCME transforms client key message, order placement input inputs, via SKCME components (e.g., MKG, OP, OE, CM), into order placement output outputs.

The SKCME component enabling access of information between nodes may be developed by employing various development tools and languages such as, but not limited to: Apache® components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's® ActiveX; Adobe® AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo!® User Interface; and/or the like), WebObjects®, and/or the like. In one embodiment, the SKCME server employs a cryptographic server to encrypt and decrypt communications. The SKCME component may communicate to and/or with other components in a component collection, including itself, and/or facilities of the like. Most frequently, the SKCME component communicates with the SKCME database, operating systems, other program components, and/or the like. The SKCME may contain, communicate, generate, obtain, and/or provide program component, system, user, and/or data communications, requests, and/or responses.

### Distributed SKCMEs

The structure and/or operation of any of the SKCME node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion. As such a combination of hardware may be distributed within a location, within a region and/or globally where logical access to a controller may be abstracted as a singular node, yet where a multitude of private, semiprivate and publicly accessible node controllers (e.g., via dispersed data centers) are coordinated to serve requests (e.g., providing private cloud, semi-private cloud, and public cloud computing resources) and allowing for the serving of such requests in discrete regions (e.g., isolated, local, regional, national, global cloud access).

The component collection may be consolidated and/or distributed in countless variations through various data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through various data processing communication techniques.

The configuration of the SKCME controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like. For example, cloud services such as Amazon Data Services®, Microsoft Azure®, Hewlett Packard Helion®, IBM® Cloud services allow for SKCME controller and/or SKCME component collections to be hosted in full or partially for varying degrees of scale.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the SKCME controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via an SSL connection, parse the data to extract variables, and store the data to a database, is provided below:

<?PHP
header(′Content-Type: text/plain′);
// set ip address and port to listen to for incoming data
$address = ‘192.168.0.100’;
$port = 255;
// create a server-side SSL socket, listen for/accept incoming communication
$sock = socket_create(AF_INET, SOCK_STREAM, 0);
socket_bind($sock, $address, $port) or die(‘Could not bind to address');
socket_listen($sock);
$client = socket_accept($sock);
// read input data from client device in 1024 byte blocks until end of message
do {

$input = “”;
$input = socket_read($client, 1024);
$data .= $input;

} while($input != “”);
// parse data to extract variables
$obj = json_decode($data, true);
// store input data in a database
mysql_connect(″201.408.185.132″,$DBserver,$password); // access database server
mysql_select(″CLIENT_DB.SQL″); // select database to append
mysql_query(“INSERT INTO UserTable (transmission)
VALUES ($data)”); // add data to UserTable table in a CLIENT database
mysql_close(″CLIENT_DB.SQL″); // close connection to database
?>

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/index.jsp?topic=/com.ibm.IBMDI.d
oc/referenceguide295.htm

and other parser implementations:

http://publib.boulder.ibm.com/infocenter/tivihelp/v2r1/index.jsp?topic=/com.ibm.IBMDI.d
oc/referenceguide259.htm

all of which are hereby expressly incorporated by reference.

Additional embodiments may include:
1. A secret key-based counterparty matching apparatus, comprising:
a memory;
a component collection in the memory, including:
   a matched key generating component, and
   an order processing component;
a processor disposed in communication with the memory, and configured to issue a plurality of processing instructions from the component collection stored in the memory,
   wherein the processor issues instructions from the matched key generating component, stored in the memory, to:
      generate, via at least one processor, a secret matched key associated with a security identifier;
      convert, via at least one processor, the matched key into an initializer value using a conversion calculation;
      set, via at least one processor, a random generator seed of a random number generator to the initializer value;
      determine, via at least one processor, a cross frequency for the security identifier;
      generate, via at least one processor, a set of cross times for the security identifier using a sequence from the random number generator and the cross frequency; and
      generate, via at least one processor, a set of cross venue identifiers for the security identifier using a sequence from the random number generator and the cross frequency, wherein the cardinality of the set of cross times is equal to the cardinality of the set of cross venue identifiers;
   wherein the processor issues instructions from the order processing component, stored in the memory, to:
      obtain, via at least one processor, a first order associated with the security identifier from a first counterparty;
      determine, via at least one processor, a scheduled cross time, from the set of cross times for the security identifier, for the first order;
      determine, via at least one processor, a cross venue identifier, from the set of cross venue identifiers for the security identifier, that corresponds to the scheduled cross time;
      add, via at least one processor, a first order datastructure for the first order to a set of pending orders for the security specified by the security identifier to be executed at the scheduled cross time at the venue specified by the cross venue identifier;
      obtain, via at least one processor, a second order associated with the security identifier from a second counterparty;
      determine, via at least one processor, the scheduled cross time, from the set of cross times for the security identifier, for the second order;
      determine, via at least one processor, the cross venue identifier, from the set of cross venue identifiers for the security identifier, that corresponds to the scheduled cross time;
      add, via at least one processor, a second order datastructure for the second order to the set of pending orders for the security specified by the security identifier to be executed at the scheduled cross time at the venue specified by the cross venue identifier; and
      send, via at least one processor, orders in the set of pending orders for the security specified by the security identifier for execution at the venue specified by the cross venue identifier.
2. The apparatus of embodiment 1, wherein the matched key is generated using a set of client keys that includes a client key from the first counterparty and the second counterparty.
3. The apparatus of embodiment 1, wherein the matched key is an individual key for the security identifier.
4. The apparatus of embodiment 1, wherein the matched key is a derived key for the security identifier generated based on a master matched key utilized for a specified duration.
5. The apparatus of embodiment 4, wherein the derived key is converted into the initializer value using a concatenation method.
6. The apparatus of embodiment 4, wherein the derived key is converted into the initializer value using a modulo sum method.
7. The apparatus of embodiment 1, wherein the initializer value is an integer value.
8. The apparatus of embodiment 1, wherein the cross times are generated to provide one cross time per minute.
9. The apparatus of embodiment 1, wherein the cross times are generated using exponential distribution between time.
10. The apparatus of embodiment 1, wherein the set of cross times for the security identifier is ordered in ascending order, and wherein the scheduled cross time is the next available cross time, from the set of cross times for the security identifier, at the time of obtaining the first order.
11. The apparatus of embodiment 1, wherein the venue is one of a stock exchange, a dark pool.
12. The apparatus of embodiment 1, wherein the orders in the set of pending orders are sent to the venue.
13. The apparatus of embodiment 1, further, comprising:
   the processor issues instructions from the order processing component, stored in the memory, to:
      select, via at least one processor, a first broker dealer, from available trusted broker dealers, for the first order;
      select, via at least one processor, a second broker dealer, from available trusted broker dealers, for the second order; and
      wherein the first order, in the set of pending orders, is sent to the first broker dealer for execution at the venue, and the second order, in the set of pending orders, is sent to the second broker dealer for execution at the venue.
14. The apparatus of embodiment 13, wherein the first broker dealer utilizes the matched key to determine the scheduled cross time and the cross venue identifier for the first order, and wherein the second broker dealer utilizes the matched key to determine the scheduled cross time and the cross venue identifier for the second order.
15. The apparatus of embodiment 1, wherein the orders in the set of pending orders are sent for execution at the scheduled cross time.
16. The apparatus of embodiment 1, wherein the orders in the set of pending orders are sent for execution a specified amount of latency mitigation time before the scheduled cross time.
17. The apparatus of embodiment 1, further, comprising:
   the processor issues instructions from the order processing component, stored in the memory, to:
      determine, via at least one processor, that the first order was partially filled;
      update, via at least one processor, the first order by modifying the first order datastructure to reflect the remaining quantity to be filled;
      determine, via at least one processor, a second scheduled cross time, from the set of cross times for the security identifier, for the updated first order;
      determine, via at least one processor, a second cross venue identifier, from the set of cross venue identifiers for the security identifier, that corresponds to the second scheduled cross time;
      add, via at least one processor, the modified first order datastructure for the updated first order to a second set of pending orders for the security specified by the security identifier to be executed at the second scheduled cross time at the venue specified by the second cross venue identifier; and
      send, via at least one processor, orders in the second set of pending orders for the security specified by the security identifier for execution at the venue specified by the second cross venue identifier.
18. A processor-readable secret key-based counterparty matching non-transient physical medium storing processor-executable components, the components, comprising:
a component collection stored in the medium, including:
   a matched key generating component, and
   an order processing component;
   wherein the matched key generating component, stored in the medium, includes processor-issuable instructions to:
      generate, via at least one processor, a secret matched key associated with a security identifier;
      convert, via at least one processor, the matched key into an initializer value using a conversion calculation;
      set, via at least one processor, a random generator seed of a random number generator to the initializer value;
      determine, via at least one processor, a cross frequency for the security identifier;
      generate, via at least one processor, a set of cross times for the security identifier using a sequence from the random number generator and the cross frequency; and
      generate, via at least one processor, a set of cross venue identifiers for the security identifier using a sequence from the random number generator and the cross frequency, wherein the cardinality of the set of cross times is equal to the cardinality of the set of cross venue identifiers;
   wherein the order processing component, stored in the medium, includes processor-issuable instructions to:
      obtain, via at least one processor, a first order associated with the security identifier from a first counterparty;
      determine, via at least one processor, a scheduled cross time, from the set of cross times for the security identifier, for the first order;
      determine, via at least one processor, a cross venue identifier, from the set of cross venue identifiers for the security identifier, that corresponds to the scheduled cross time;
      add, via at least one processor, a first order datastructure for the first order to a set of pending orders for the security specified by the security identifier to be executed at the scheduled cross time at the venue specified by the cross venue identifier;
      obtain, via at least one processor, a second order associated with the security identifier from a second counterparty;
      determine, via at least one processor, the scheduled cross time, from the set of cross times for the security identifier, for the second order;
      determine, via at least one processor, the cross venue identifier, from the set of cross venue identifiers for the security identifier, that corresponds to the scheduled cross time;
      add, via at least one processor, a second order datastructure for the second order to the set of pending orders for the security specified by the security identifier to be executed at the scheduled cross time at the venue specified by the cross venue identifier; and
      send, via at least one processor, orders in the set of pending orders for the security specified by the security identifier for execution at the venue specified by the cross venue identifier.
19. The medium of embodiment 18, wherein the matched key is generated using a set of client keys that includes a client key from the first counterparty and the second counterparty.
20. The medium of embodiment 18, wherein the matched key is an individual key for the security identifier.
21. The medium of embodiment 18, wherein the matched key is a derived key for the security identifier generated based on a master matched key utilized for a specified duration.
22. The medium of embodiment 21, wherein the derived key is converted into the initializer value using a concatenation method.
23. The medium of embodiment 21, wherein the derived key is converted into the initializer value using a modulo sum method.
24. The medium of embodiment 18, wherein the initializer value is an integer value.
25. The medium of embodiment 18, wherein the cross times are generated to provide one cross time per minute.
26. The medium of embodiment 18, wherein the cross times are generated using exponential distribution between time.
27. The medium of embodiment 18, wherein the set of cross times for the security identifier is ordered in ascending order, and wherein the scheduled cross time is the next available cross time, from the set of cross times for the security identifier, at the time of obtaining the first order.
28. The medium of embodiment 18, wherein the venue is one of a stock exchange, a dark pool.
29. The medium of embodiment 18, wherein the orders in the set of pending orders are sent to the venue.
30. The medium of embodiment 18, further, comprising:
   the order processing component, stored in the medium, includes processor-issuable instructions to:
      select, via at least one processor, a first broker dealer, from available trusted broker dealers, for the first order;
      select, via at least one processor, a second broker dealer, from available trusted broker dealers, for the second order; and
      wherein the first order, in the set of pending orders, is sent to the first broker dealer for execution at the venue, and the second order, in the set of pending orders, is sent to the second broker dealer for execution at the venue.
31. The medium of embodiment 30, wherein the first broker dealer utilizes the matched key to determine the scheduled cross time and the cross venue identifier for the first order, and wherein the second broker dealer utilizes the matched key to determine the scheduled cross time and the cross venue identifier for the second order.
32. The medium of embodiment 18, wherein the orders in the set of pending orders are sent for execution at the scheduled cross time.
33. The medium of embodiment 18, wherein the orders in the set of pending orders are sent for execution a specified amount of latency mitigation time before the scheduled cross time.
34. The medium of embodiment 18, further, comprising:
   the order processing component, stored in the medium, includes processor-issuable instructions to:
      determine, via at least one processor, that the first order was partially filled;
      update, via at least one processor, the first order by modifying the first order datastructure to reflect the remaining quantity to be filled;
      determine, via at least one processor, a second scheduled cross time, from the set of cross times for the security identifier, for the updated first order;
      determine, via at least one processor, a second cross venue identifier, from the set of cross venue identifiers for the security identifier, that corresponds to the second scheduled cross time;
      add, via at least one processor, the modified first order datastructure for the updated first order to a second set of pending orders for the security specified by the security identifier to be executed at the second scheduled cross time at the venue specified by the second cross venue identifier; and
      send, via at least one processor, orders in the second set of pending orders for the security specified by the security identifier for execution at the venue specified by the second cross venue identifier.
35. A processor-implemented secret key-based counterparty matching system, comprising:
   a matched key generating component means, to:
      generate, via at least one processor, a secret matched key associated with a security identifier;
      convert, via at least one processor, the matched key into an initializer value using a conversion calculation;
      set, via at least one processor, a random generator seed of a random number generator to the initializer value;
      determine, via at least one processor, a cross frequency for the security identifier;
      generate, via at least one processor, a set of cross times for the security identifier using a sequence from the random number generator and the cross frequency; and
      generate, via at least one processor, a set of cross venue identifiers for the security identifier using a sequence from the random number generator and the cross frequency, wherein the cardinality of the set of cross times is equal to the cardinality of the set of cross venue identifiers;
   an order processing component means, to:
      obtain, via at least one processor, a first order associated with the security identifier from a first counterparty;
      determine, via at least one processor, a scheduled cross time, from the set of cross times for the security identifier, for the first order;
      determine, via at least one processor, a cross venue identifier, from the set of cross venue identifiers for the security identifier, that corresponds to the scheduled cross time;
      add, via at least one processor, a first order datastructure for the first order to a set of pending orders for the security specified by the security identifier to be executed at the scheduled cross time at the venue specified by the cross venue identifier;
      obtain, via at least one processor, a second order associated with the security identifier from a second counterparty;
      determine, via at least one processor, the scheduled cross time, from the set of cross times for the security identifier, for the second order;
      determine, via at least one processor, the cross venue identifier, from the set of cross venue identifiers for the security identifier, that corresponds to the scheduled cross time;
      add, via at least one processor, a second order datastructure for the second order to the set of pending orders for the security specified by the security identifier to be executed at the scheduled cross time at the venue specified by the cross venue identifier; and
      send, via at least one processor, orders in the set of pending orders for the security specified by the security identifier for execution at the venue specified by the cross venue identifier.
36. The system of embodiment 35, wherein the matched key is generated using a set of client keys that includes a client key from the first counterparty and the second counterparty.
37. The system of embodiment 35, wherein the matched key is an individual key for the security identifier.
38. The system of embodiment 35, wherein the matched key is a derived key for the security identifier generated based on a master matched key utilized for a specified duration.
39. The system of embodiment 38, wherein the derived key is converted into the initializer value using a concatenation method.
40. The system of embodiment 38, wherein the derived key is converted into the initializer value using a modulo sum method.
41. The system of embodiment 35, wherein the initializer value is an integer value.
42. The system of embodiment 35, wherein the cross times are generated to provide one cross time per minute.
43. The system of embodiment 35, wherein the cross times are generated using exponential distribution between time.
44. The system of embodiment 35, wherein the set of cross times for the security identifier is ordered in ascending order, and wherein the scheduled cross time is the next available cross time, from the set of cross times for the security identifier, at the time of obtaining the first order.
45. The system of embodiment 35, wherein the venue is one of a stock exchange, a dark pool.
46. The system of embodiment 35, wherein the orders in the set of pending orders are sent to the venue.
47. The system of embodiment 35, further, comprising:
   the order processing component means, to:
      select, via at least one processor, a first broker dealer, from available trusted broker dealers, for the first order;
      select, via at least one processor, a second broker dealer, from available trusted broker dealers, for the second order; and
      wherein the first order, in the set of pending orders, is sent to the first broker dealer for execution at the venue, and the second order, in the set of pending orders, is sent to the second broker dealer for execution at the venue.
48. The system of embodiment 47, wherein the first broker dealer utilizes the matched key to determine the scheduled cross time and the cross venue identifier for the first order, and wherein the second broker dealer utilizes the matched key to determine the scheduled cross time and the cross venue identifier for the second order.
49. The system of embodiment 35, wherein the orders in the set of pending orders are sent for execution at the scheduled cross time.
50. The system of embodiment 35, wherein the orders in the set of pending orders are sent for execution a specified amount of latency mitigation time before the scheduled cross time.
51. The system of embodiment 35, further, comprising:
   the order processing component means, to:
      determine, via at least one processor, that the first order was partially filled;
      update, via at least one processor, the first order by modifying the first order datastructure to reflect the remaining quantity to be filled;
      determine, via at least one processor, a second scheduled cross time, from the set of cross times for the security identifier, for the updated first order;
      determine, via at least one processor, a second cross venue identifier, from the set of cross venue identifiers for the security identifier, that corresponds to the second scheduled cross time;
      add, via at least one processor, the modified first order datastructure for the updated first order to a second set of pending orders for the security specified by the security identifier to be executed at the second scheduled cross time at the venue specified by the second cross venue identifier; and
      send, via at least one processor, orders in the second set of pending orders for the security specified by the security identifier for execution at the venue specified by the second cross venue identifier.
52. A processor-implemented secret key-based counterparty matching method, comprising:
   executing processor-implemented matched key generating component instructions to:
      generate, via at least one processor, a secret matched key associated with a security identifier;
      convert, via at least one processor, the matched key into an initializer value using a conversion calculation;
      set, via at least one processor, a random generator seed of a random number generator to the initializer value;
      determine, via at least one processor, a cross frequency for the security identifier;
      generate, via at least one processor, a set of cross times for the security identifier using a sequence from the random number generator and the cross frequency; and
      generate, via at least one processor, a set of cross venue identifiers for the security identifier using a sequence from the random number generator and the cross frequency, wherein the cardinality of the set of cross times is equal to the cardinality of the set of cross venue identifiers;
   executing processor-implemented order processing component instructions to:
      obtain, via at least one processor, a first order associated with the security identifier from a first counterparty;
      determine, via at least one processor, a scheduled cross time, from the set of cross times for the security identifier, for the first order;
      determine, via at least one processor, a cross venue identifier, from the set of cross venue identifiers for the security identifier, that corresponds to the scheduled cross time;
      add, via at least one processor, a first order datastructure for the first order to a set of pending orders for the security specified by the security identifier to be executed at the scheduled cross time at the venue specified by the cross venue identifier;
      obtain, via at least one processor, a second order associated with the security identifier from a second counterparty;
      determine, via at least one processor, the scheduled cross time, from the set of cross times for the security identifier, for the second order;
      determine, via at least one processor, the cross venue identifier, from the set of cross venue identifiers for the security identifier, that corresponds to the scheduled cross time;
      add, via at least one processor, a second order datastructure for the second order to the set of pending orders for the security specified by the security identifier to be executed at the scheduled cross time at the venue specified by the cross venue identifier; and
      send, via at least one processor, orders in the set of pending orders for the security specified by the security identifier for execution at the venue specified by the cross venue identifier.
53. The method of embodiment 52, wherein the matched key is generated using a set of client keys that includes a client key from the first counterparty and the second counterparty.
54. The method of embodiment 52, wherein the matched key is an individual key for the security identifier.
55. The method of embodiment 52, wherein the matched key is a derived key for the security identifier generated based on a master matched key utilized for a specified duration.
56. The method of embodiment 55, wherein the derived key is converted into the initializer value using a concatenation method.
57. The method of embodiment 55, wherein the derived key is converted into the initializer value using a modulo sum method.
58. The method of embodiment 52, wherein the initializer value is an integer value.
59. The method of embodiment 52, wherein the cross times are generated to provide one cross time per minute.
60. The method of embodiment 52, wherein the cross times are generated using exponential distribution between time.
61. The method of embodiment 52, wherein the set of cross times for the security identifier is ordered in ascending order, and wherein the scheduled cross time is the next available cross time, from the set of cross times for the security identifier, at the time of obtaining the first order.
62. The method of embodiment 52, wherein the venue is one of a stock exchange, a dark pool.
63. The method of embodiment 52, wherein the orders in the set of pending orders are sent to the venue.
64. The method of embodiment 52, further, comprising:
   executing processor-implemented order processing component instructions to:
      select, via at least one processor, a first broker dealer, from available trusted broker dealers, for the first order;
      select, via at least one processor, a second broker dealer, from available trusted broker dealers, for the second order; and
      wherein the first order, in the set of pending orders, is sent to the first broker dealer for execution at the venue, and the second order, in the set of pending orders, is sent to the second broker dealer for execution at the venue.
65. The method of embodiment 64, wherein the first broker dealer utilizes the matched key to determine the scheduled cross time and the cross venue identifier for the first order, and wherein the second broker dealer utilizes the matched key to determine the scheduled cross time and the cross venue identifier for the second order.
66. The method of embodiment 52, wherein the orders in the set of pending orders are sent for execution at the scheduled cross time.
67. The method of embodiment 52, wherein the orders in the set of pending orders are sent for execution a specified amount of latency mitigation time before the scheduled cross time.
68. The method of embodiment 52, further, comprising:
   executing processor-implemented order processing component instructions to:
      determine, via at least one processor, that the first order was partially filled;
      update, via at least one processor, the first order by modifying the first order datastructure to reflect the remaining quantity to be filled;
      determine, via at least one processor, a second scheduled cross time, from the set of cross times for the security identifier, for the updated first order;
      determine, via at least one processor, a second cross venue identifier, from the set of cross venue identifiers for the security identifier, that corresponds to the second scheduled cross time;
      add, via at least one processor, the modified first order datastructure for the updated first order to a second set of pending orders for the security specified by the security identifier to be executed at the second scheduled cross time at the venue specified by the second cross venue identifier; and
      send, via at least one processor, orders in the second set of pending orders for the security specified by the security identifier for execution at the venue specified by the second cross venue identifier.

In order to address various issues and advance the art, the entirety of this application for Secret Key-Based Counterparty Matching Engine Apparatuses, Methods and Systems (including the Cover Page, Title, Headings, Field, Background, Summary, Brief Description of the Drawings, Detailed Description, Claims, Abstract, Figures, Appendices, and otherwise) shows, by way of illustration, various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Further and to the extent any financial and/or investment examples are included, such examples are for illustrative purpose(s) only, and are not, nor should they be interpreted, as investment advice. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components, data flow order, logic flow order, and/or any present feature sets as described in the figures and/or throughout are not limited to a fixed operating order and/or arrangement, but rather, any disclosed order is exemplary and all equivalents, regardless of order, are contemplated by the disclosure. Similarly, descriptions of embodiments disclosed throughout this disclosure, any reference to direction or orientation is merely intended for convenience of description and is not intended in any way to limit the scope of described embodiments. Relative terms such as “lower”, “upper”, “horizontal”, “vertical”, “above”, “below”, “up”, “down”, “top” and “bottom” as well as derivative thereof (e.g., “horizontally”, “downwardly”, “upwardly”, etc.) should not be construed to limit embodiments, and instead, again, are offered for convenience of description of orientation. These relative descriptors are for convenience of description only and do not require that any embodiments be constructed or operated in a particular orientation unless explicitly indicated as such. Terms such as “attached”, “affixed”, “connected”, “coupled”, “interconnected”, and similar may refer to a relationship wherein structures are secured or attached to one another either directly or indirectly through intervening structures, as well as both movable or rigid attachments or relationships, unless expressly described otherwise. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations in part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a SKCME individual and/or enterprise user, database configuration and/or relational model, data type, data transmission and/or network framework, syntax structure, and/or the like, various embodiments of the SKCME, may be implemented that allow a great deal of flexibility and customization. For example, aspects of the SKCME may be adapted for secure communication among a set of trusted users. While various embodiments and discussions of the SKCME have included security, however, it is to be understood that the embodiments described herein may be readily configured and/or customized for a wide variety of other applications and/or implementations.

What is claimed is:

1. A secret key-based counterparty matching apparatus, comprising:
a memory;
a component collection in the memory, including:
a matched key generating component, and
an order processing component;
a processor disposed in communication with the memory, and configured to issue a plurality of processing instructions from the component collection stored in the memory,
wherein the processor issues instructions from the matched key generating component, stored in the memory, to:
generate, via at least one processor, a secret matched key associated with a security identifier;
convert, via at least one processor, the matched key into an initializer value using a conversion calculation;
set, via at least one processor, a random generator seed of a random number generator to the initializer value;
determine, via at least one processor, a cross frequency for the security identifier;
generate, via at least one processor, a set of cross times for the security identifier using a sequence from the random number generator and the cross frequency; and
generate, via at least one processor, a set of cross venue identifiers for the security identifier using a sequence from the random number generator and the cross frequency, wherein the cardinality of the set of cross times is equal to the cardinality of the set of cross venue identifiers;
wherein the processor issues instructions from the order processing component, stored in the memory, to:
obtain, via at least one processor, a first order associated with the security identifier from a first counterparty;
determine, via at least one processor, a scheduled cross time, from the set of cross times for the security identifier, for the first order;
determine, via at least one processor, a cross venue identifier, from the set of cross venue identifiers for the security identifier, that corresponds to the scheduled cross time;
add, via at least one processor, a first order datastructure for the first order to a set of pending orders for the security specified by the security identifier to be executed at the scheduled cross time at the venue specified by the cross venue identifier;
obtain, via at least one processor, a second order associated with the security identifier from a second counterparty;
determine, via at least one processor, the scheduled cross time, from the set of cross times for the security identifier, for the second order;
determine, via at least one processor, the cross venue identifier, from the set of cross venue identifiers for the security identifier, that corresponds to the scheduled cross time;
add, via at least one processor, a second order datastructure for the second order to the set of pending orders for the security specified by the security identifier to be executed at the scheduled cross time at the venue specified by the cross venue identifier; and
send, via at least one processor, orders in the set of pending orders for the security specified by the security identifier for execution at the venue specified by the cross venue identifier.

2. The apparatus of claim 1, wherein the matched key is generated using a set of client keys that includes a client key from the first counterparty and the second counterparty.

3. The apparatus of claim 1, wherein the matched key is an individual key for the security identifier.

4. The apparatus of claim 1, wherein the matched key is a derived key for the security identifier generated based on a master matched key utilized for a specified duration.

5. The apparatus of claim 4, wherein the derived key is converted into the initializer value using a concatenation method.

6. The apparatus of claim 4, wherein the derived key is converted into the initializer value using a modulo sum method.

7. The apparatus of claim 1, wherein the initializer value is an integer value.

8. The apparatus of claim 1, wherein the cross times are generated to provide one cross time per minute.

9. The apparatus of claim 1, wherein the cross times are generated using exponential distribution between time.

10. The apparatus of claim 1, wherein the set of cross times for the security identifier is ordered in ascending order, and wherein the scheduled cross time is the next available cross time, from the set of cross times for the security identifier, at the time of obtaining the first order.

11. The apparatus of claim 1, wherein the venue is one of a stock exchange, a dark pool.

12. The apparatus of claim 1, wherein the orders in the set of pending orders are sent to the venue.

13. The apparatus of claim 1, further, comprising:
the processor issues instructions from the order processing component, stored in the memory, to:
select, via at least one processor, a first broker dealer, from available trusted broker dealers, for the first order;
select, via at least one processor, a second broker dealer, from available trusted broker dealers, for the second order; and
wherein the first order, in the set of pending orders, is sent to the first broker dealer for execution at the venue, and the second order, in the set of pending orders, is sent to the second broker dealer for execution at the venue.

14. The apparatus of claim 13, wherein the first broker dealer utilizes the matched key to determine the scheduled cross time and the cross venue identifier for the first order, and wherein the second broker dealer utilizes the matched key to determine the scheduled cross time and the cross venue identifier for the second order.

15. The apparatus of claim 1, wherein the orders in the set of pending orders are sent for execution at the scheduled cross time.

16. The apparatus of claim 1, wherein the orders in the set of pending orders are sent for execution a specified amount of latency mitigation time before the scheduled cross time.

17. The apparatus of claim 1, further, comprising:
the processor issues instructions from the order processing component, stored in the memory, to:
determine, via at least one processor, that the first order was partially filled;
update, via at least one processor, the first order by modifying the first order datastructure to reflect the remaining quantity to be filled;
determine, via at least one processor, a second scheduled cross time, from the set of cross times for the security identifier, for the updated first order;
determine, via at least one processor, a second cross venue identifier, from the set of cross venue identifiers for the security identifier, that corresponds to the second scheduled cross time;
add, via at least one processor, the modified first order datastructure for the updated first order to a second set of pending orders for the security specified by the security identifier to be executed at the second scheduled cross time at the venue specified by the second cross venue identifier; and
send, via at least one processor, orders in the second set of pending orders for the security specified by the security identifier for execution at the venue specified by the second cross venue identifier.

18. A processor-readable secret key-based counterparty matching non-transient physical medium storing processor-executable components, the components, comprising:
a component collection stored in the medium, including:
a matched key generating component, and
an order processing component;
wherein the matched key generating component, stored in the medium, includes processor-issuable instructions to:
generate, via at least one processor, a secret matched key associated with a security identifier;
convert, via at least one processor, the matched key into an initializer value using a conversion calculation;
set, via at least one processor, a random generator seed of a random number generator to the initializer value;
determine, via at least one processor, a cross frequency for the security identifier;
generate, via at least one processor, a set of cross times for the security identifier using a sequence from the random number generator and the cross frequency; and
generate, via at least one processor, a set of cross venue identifiers for the security identifier using a sequence from the random number generator and the cross frequency, wherein the cardinality of the set of cross times is equal to the cardinality of the set of cross venue identifiers;
wherein the order processing component, stored in the medium, includes processor-issuable instructions to:
obtain, via at least one processor, a first order associated with the security identifier from a first counterparty;
determine, via at least one processor, a scheduled cross time, from the set of cross times for the security identifier, for the first order;
determine, via at least one processor, a cross venue identifier, from the set of cross venue identifiers for the security identifier, that corresponds to the scheduled cross time;
add, via at least one processor, a first order datastructure for the first order to a set of pending orders for the security specified by the security identifier to be executed at the scheduled cross time at the venue specified by the cross venue identifier;
obtain, via at least one processor, a second order associated with the security identifier from a second counterparty;
determine, via at least one processor, the scheduled cross time, from the set of cross times for the security identifier, for the second order;
determine, via at least one processor, the cross venue identifier, from the set of cross venue identifiers for the security identifier, that corresponds to the scheduled cross time;
add, via at least one processor, a second order datastructure for the second order to the set of pending orders for the security specified by the security identifier to be executed at the scheduled cross time at the venue specified by the cross venue identifier; and
send, via at least one processor, orders in the set of pending orders for the security specified by the security identifier for execution at the venue specified by the cross venue identifier.

19. A processor-implemented secret key-based counterparty matching system, comprising:
a matched key generating component means, to:
generate, via at least one processor, a secret matched key associated with a security identifier;
convert, via at least one processor, the matched key into an initializer value using a conversion calculation;
set, via at least one processor, a random generator seed of a random number generator to the initializer value;
determine, via at least one processor, a cross frequency for the security identifier;
generate, via at least one processor, a set of cross times for the security identifier using a sequence from the random number generator and the cross frequency; and
generate, via at least one processor, a set of cross venue identifiers for the security identifier using a sequence from the random number generator and the cross frequency, wherein the cardinality of the set of cross times is equal to the cardinality of the set of cross venue identifiers;
an order processing component means, to:
obtain, via at least one processor, a first order associated with the security identifier from a first counterparty;
determine, via at least one processor, a scheduled cross time, from the set of cross times for the security identifier, for the first order;
determine, via at least one processor, a cross venue identifier, from the set of cross venue identifiers for the security identifier, that corresponds to the scheduled cross time;
add, via at least one processor, a first order datastructure for the first order to a set of pending orders for the security specified by the security identifier to be executed at the scheduled cross time at the venue specified by the cross venue identifier;
obtain, via at least one processor, a second order associated with the security identifier from a second counterparty;
determine, via at least one processor, the scheduled cross time, from the set of cross times for the security identifier, for the second order;
determine, via at least one processor, the cross venue identifier, from the set of cross venue identifiers for the security identifier, that corresponds to the scheduled cross time;
add, via at least one processor, a second order datastructure for the second order to the set of pending orders for the security specified by the security identifier to be executed at the scheduled cross time at the venue specified by the cross venue identifier; and
send, via at least one processor, orders in the set of pending orders for the security specified by the security identifier for execution at the venue specified by the cross venue identifier.

20. A processor-implemented secret key-based counterparty matching method, comprising:
executing processor-implemented matched key generating component instructions to:
generate, via at least one processor, a secret matched key associated with a security identifier;
convert, via at least one processor, the matched key into an initializer value using a conversion calculation;
set, via at least one processor, a random generator seed of a random number generator to the initializer value;
determine, via at least one processor, a cross frequency for the security identifier;
generate, via at least one processor, a set of cross times for the security identifier using a sequence from the random number generator and the cross frequency; and
generate, via at least one processor, a set of cross venue identifiers for the security identifier using a sequence from the random number generator and the cross frequency, wherein the cardinality of the set of cross times is equal to the cardinality of the set of cross venue identifiers;
executing processor-implemented order processing component instructions to:
obtain, via at least one processor, a first order associated with the security identifier from a first counterparty;
determine, via at least one processor, a scheduled cross time, from the set of cross times for the security identifier, for the first order;
determine, via at least one processor, a cross venue identifier, from the set of cross venue identifiers for the security identifier, that corresponds to the scheduled cross time;
add, via at least one processor, a first order datastructure for the first order to a set of pending orders for the security specified by the security identifier to be executed at the scheduled cross time at the venue specified by the cross venue identifier;
obtain, via at least one processor, a second order associated with the security identifier from a second counterparty;
determine, via at least one processor, the scheduled cross time, from the set of cross times for the security identifier, for the second order;
determine, via at least one processor, the cross venue identifier, from the set of cross venue identifiers for the security identifier, that corresponds to the scheduled cross time;
add, via at least one processor, a second order datastructure for the second order to the set of pending orders for the security specified by the security identifier to be executed at the scheduled cross time at the venue specified by the cross venue identifier; and
send, via at least one processor, orders in the set of pending orders for the security specified by the security identifier for execution at the venue specified by the cross venue identifier.
